(19) United States
(12) Patent Application Publication
(10) Pub. No.: US 2023/0112425 A1
(43) Pub. Date: Apr. 13, 2023

(54) COATED GLASS ARTICLES WITH ADHESION PROMOTING REGION

(71) Applicant: CORNING INCORPORATED, Corning, NY (US)

(72) Inventors: Dane Alphanso Christie, Painted Post, NY (US); Richard Michael Fiacco, Corning, NY (US); Insik Jeon, Novi, MI (US); Eric Emil Leonhardt, Horseheads, NY (US)

(21) Appl. No.: 17/948,899

(22) Filed: Sep. 20, 2022

Related U.S. Application Data
(60) Provisional application No. 63/246,406, filed on Sep. 21, 2021.

(51) Int. Cl. C03C 15/00; C03C 17/32; C03C 17/00; B65D 25/34

(52) U.S. Cl. CPC C03C 15/00; C03C 17/32; C03C 17/009; C03C 17/005; B65D 25/34; C03C 2217/445; C03C 2217/478; C03C 2218/31; C03C 2218/111

(57) ABSTRACT

A coated glass article includes a glass article comprising a glass having a surface. The surface has an adhesion promoting region comprising a nanostructure formed at the surface of the glass. The adhesion promoting region is constructed of materials that are the same as one or more constituents of a glass composition of the glass. The coated glass article further includes a coating disposed on the adhesion promoting region formed at the surface of the glass. The coating incudes one or more polymer coating materials. The adhesion promoting region improves adhesion of the coating to the glass while also eliminating the use of titania or other adhesion promoting compounds that can adversely affect the optical properties of the coatings.

### CROSS-REFERENCE TO RELATED APPLICATIONS

This application claims the benefit of priority under 35 U.S.C. § 119 of U.S. Provisional Application Ser. No. 63/246,406 filed on Sep. 21, 2021, the content of which is relied upon and incorporated herein by reference in its entirety.

### BACKGROUND

### Field

The present specification generally relates glass articles, more specifically, to glass containers and coated glass containers for pharmaceutical packages.

### Technical Background

Historically, glass has been used as the preferred material for packaging pharmaceuticals because of its hermeticity, optical clarity, and excellent chemical durability relative to other materials. Specifically, the glass used in pharmaceutical packaging must have adequate chemical durability so as not to affect the stability of the pharmaceutical compositions contained therein. Glasses having suitable chemical durability include those glass compositions within the ASTM standard ‘Type 1B’ which have a proven history of chemical durability.

However, use of glass for such applications is limited by the mechanical performance of the glass. In the pharmaceutical industry, glass breakage is a safety concern for the end user, as the broken package and/or the contents of the package may injure the end user. Further, non-catastrophic breakage (i.e., when the glass cracks but does not break) may cause the contents to lose their sterility which, in turn, may result in costly product recalls. Accordingly, ongoing needs exist for alternative glass articles which have improved resistance to mechanical damage.

### SUMMARY

The present disclosure is directed to coated glass articles and methods of coating the glass articles that include treating a surface of the glass article to form an adhesion promoting region at the surface of the glass and then, thereafter, coating the glass article with a coating material to produce the coated glass article. The adhesion promoting region of the coated glass article may have a greater surface area compared to the untreated surface of the glass article prior to treatment or coating. This increased surface area may provide increased adhesion of the coating materials, such as but not limited to polymer coating materials, to the glass without the use of adhesion promoting agents mixed into the coating. This may reduce or prevent changes in optical properties of the glass article and may enable the use of single component polymer coating materials, among other features.

According to a first aspect disclosed herein, a glass container may comprise a glass having a surface. The surface may comprise an adhesion promoting region comprising a nanostructure formed at the surface of the glass. The adhesion promoting region may comprise materials that are the same as one or more constituents of a glass composition of the glass, and the adhesion promoting region may have a surface roughness of greater than or equal to 0.3 nm.

A second aspect of the present disclosure may include the first aspect, further comprising a coating disposed on the adhesion promoting region formed into the surface of the glass.

According to a third aspect disclosed herein, a coated glass article may comprise a glass article that may comprise a glass having a surface. The surface may comprise an adhesion promoting region comprising a nanostructure formed at the surface of the glass. The adhesion promoting region may comprise materials that are the same as one or more constituents of a glass composition of the glass. The coated glass article may further comprise a coating disposed on the adhesion promoting region formed into the surface of the glass. In embodiments, the coating may include one or more polymer coating materials.

A fourth aspect of the present disclosure may include the second aspect, wherein the glass article may be a glass container comprising an exterior surface and an interior surface, wherein the exterior surface may be the surface comprising the adhesion promoting region and the coating.

A fifth aspect of the present disclosure may include any one of the first through fourth aspects, wherein the adhesion promoting region may comprise one or more constituents of the glass that are present in amounts greater than or equal to 5 mol. % in the glass composition of the glass prior to formation of the adhesion promoting region.

A sixth aspect of the present disclosure may include any one of the first through fifth aspects, wherein the adhesion promoting region may comprise one or more of silica, alumina, alkali metal oxides, boron compounds, or combinations of these.

A seventh aspect of the present disclosure may include any one of the first through sixth aspects, wherein the nanostructure may comprise a plurality of peaks and valleys formed at the surface of the glass.

An eighth aspect of the present disclosure may include any one of the first through seventh aspects, wherein the adhesion promoting region may comprise a surface area of at least 1.05 times a surface area of the glass without the adhesion promoting region.

A ninth aspect of the present disclosure may include any one of the first through eighth aspects, wherein the adhesion promoting region may have a surface roughness Ra of greater than or equal to 0.3 nm.

A tenth aspect of the present disclosure may include any one of the first through ninth aspects, wherein the adhesion promoting region may be optically inert.

An eleventh aspect of the present disclosure may include any one of the first through tenth aspects, wherein the adhesion promoting region may have a refractive index of within 10% or even within 5% of a refractive index of the glass without the adhesion promoting region.

A twelfth aspect of the present disclosure may include any one of the first through eleventh aspects, wherein the adhesion promoting region may have a Pegasus Number within 10% or even within 5% of a Pegasus Number of the glass without the adhesion promoting region.

A thirteenth aspect of the present disclosure may include any one of the first through twelfth aspects, wherein the adhesion promoting region does not include titania.

A fourteenth aspect of the present disclosure may include any one of the second through thirteenth aspects, comprising a surface layer comprising the adhesion promoting region and a coating material of the coating disposed in valleys of the adhesion promoting region.

A fifteenth aspect of the present disclosure may include any one of the second through fourteenth aspects, wherein the polymer coating material may be a single component coating.

A sixteenth aspect of the present disclosure may include any one of the second through fifteenth aspects, wherein the coating may further comprise silica.

A seventeenth aspect of the present disclosure may include any one of the second through sixteenth aspects, wherein the polymer coating material may comprise, consist of, or consist essentially of a polyimide coating.

An eighteenth aspect of the present disclosure may include any one of the second through seventeenth aspects, wherein the polymer coating material may comprise a fluorinated polyimide.

A nineteenth aspect of the present disclosure may include any one of the second through eighteenth aspects, wherein the polymer coating material does not include an oxide of a metal or metalloid mixed into the polymer coating material.

A twentieth aspect of the present disclosure may include any one of the second through nineteenth aspects, wherein the coating may have a coefficient of friction of less than or equal to 0.7.

A twenty-first aspect of the present disclosure may include any one of the second through twentieth aspects, wherein the coating may be optically inert.

A twenty-second aspect of the present disclosure may include any one of the second through twenty-first aspects, wherein the adhesion promoting region and the coating may provide no impedance to optical inspection of the glass article, contents contained within the glass article, or both.

A twenty-third aspect of the present disclosure may include any one of the second through twenty-second aspects, wherein the coated glass article may have a light scattering that is different from the light scattering of the glass article without the coating and the adhesion promoting region by less than 10%, less than 5%, or less than 3%.

A twenty-fourth aspect of the present disclosure may include any one of the second through twenty-third aspects, wherein the coated glass article may have a refractive index that is different from a refractive index of the glass article without the coating and the adhesion promoting region by less than 10%, less than 5%, or less than 3%.

A twenty-fifth aspect of the present disclosure may include any one of the first through twenty-fourth aspects, wherein the coated glass article may have a Pegasus Number that is different from a Pegasus Number of the glass article without the coating and the adhesion promoting region by less than 10%, less than 5%, or less than 3%.

A twenty-sixth aspect of the present disclosure may include any one of the second through twenty-fifth aspects, wherein an outer surface of the coating may have a surface roughness Ra less than the surface roughness of the adhesion promoting region, such as a surface roughness Ra of less than 0.3.

A twenty-seventh aspect of the present disclosure may include any one of the first through twenty-sixth aspects, wherein the glass may comprise a glass composition that meets the criteria for pharmaceutical glasses described in United States Pharmacopoeia (USP) 600 or European Pharmacopoeia 7.

A twenty-eighth aspect of the present disclosure may include any one of the first through twenty-seventh aspects, wherein the glass may be a silicate glass, an aluminosilicate glass, an alkali aluminosilicate glass, an ion-exchanged aluminosilicate glass, a borosilicate glass, an ion-exchanged borosilicate glass, a soda lime glass, or combinations of these.

According to a twenty-ninth aspect disclosed herein, a method for producing a coated glass article may include providing a glass article comprising a glass having a surface and forming an adhesion promoting region at the surface. The adhesion promoting region may comprise a nanostructure comprising materials that are the same as constituents of the glass. The method may further include, after forming the adhesion promotion region at the surface, applying a coating to the adhesion promoting region to produce the coated glass article, wherein the coating may comprise at least one polymer coating material.

A thirtieth aspect of the present disclosure may include the twenty-ninth aspect, wherein the forming the adhesion promoting region at the surface may comprise contacting the surface of the glass article with an aqueous treating medium.

A thirty-first aspect of the present disclosure may include the thirtieth aspect, comprising the contacting the surface of the glass article with the aqueous treating medium that may comprise a low fluoride content aqueous solution comprising ammonium bifluoride and citric acid. The contacting may remove material from the surface of the glass article to form the nanoporous structure of the adhesion promoting region.

A thirty-second aspect of the present disclosure may include any one of the thirtieth or thirty-first aspects, wherein the aqueous treating medium may comprise from 0.026 molar (M) to 0.26 M ammonium bifluoride and from 0.5 M to 2 M citric acid.

A thirty-third aspect of the present disclosure may include any one of the thirtieth through thirty-second aspects, comprising contacting the surface of the glass article with the aqueous treating medium at a temperature of from 0° C. to 105° C. and a time of from 5 minutes to 48 hours.

A thirty-fourth aspect of the present disclosure may include any one of the thirtieth through thirty-third aspects, further comprising leaching low durability constituents from the glass at the surface of the glass before contacting with the aqueous treating medium.

A thirty-fifth aspect of the present disclosure may include the thirty-fourth aspect, wherein leaching may comprise contacting the surface of the glass container with a strong acid at a temperature of from 45° C. to 105° C. for a duration sufficient to remove low durability components from the glass to form the nanoporous structure at the surface of the glass article.

A thirty-sixth aspect of the present disclosure may include the thirty-fifth aspect, wherein the strong acid may comprise hydrochloric acid having a concentration of from 0.001 M to 12 M, or about 0.15 M.

A thirty-seventh aspect of the present disclosure may include any one of the twenty-ninth through thirty-sixth aspects, wherein the adhesion promoting region may comprise a surface area of at least 1.05 times a surface area of the glass without the adhesion promoting region.

A thirty-eighth aspect of the present disclosure may include any one of the twenty-ninth through thirty-seventh aspects, wherein the adhesion promoting region may have a surface roughness Ra of greater than or equal to 0.3 nm.

A thirty-ninth aspect of the present disclosure may include any one of the twenty-ninth through thirty-eighth aspects, wherein the adhesion promoting region may be optically inert.

A fortieth aspect of the present disclosure may include any one of the twenty-ninth through thirty-ninth aspects, wherein the adhesion promoting region may have a refractive index of within 10% or even within 5% of a refractive index of the glass without the adhesion promoting region.

A forty-first aspect of the present disclosure may include any one of the twenty-ninth through fortieth aspects, wherein coating the surface of the glass article may comprise dip coating the glass article in a coating solution.

A forty-second aspect of the present disclosure may include any one of the twenty-ninth through forty-first aspects, wherein coating the surface of the glass article may comprise dip coating the glass article in a coating solution comprising from 1 wt. % to 5 wt. % polymer coating material and a diluent.

A forty-third aspect of the present disclosure may include any one of the twenty-ninth through forty-second aspects, wherein the polymer coating material may be a single component coating material.

A forty-fourth aspect of the present disclosure may include any one of the twenty-ninth through forty-third aspects, wherein the polymer coating material may comprise, consist of, or consist essentially of a fluorinated polyimide.

A forty-fifth aspect of the present disclosure may include any one of the twenty-ninth through forty-fourth aspects, wherein the adhesion promoting region, the coating, or both may be optically inert.

A forty-sixth aspect of the present disclosure may include any one of the twenty-ninth through forty-fifth aspects, wherein the coating does not contain a metal oxide that changes the optical properties of the coated glass article.

A forty-seventh aspect of the present disclosure may include any one of the twenty-ninth through forty-sixth aspects, wherein the polymer coating material does not contain any adhesion promoting materials.

A forty-eighth aspect of the present disclosure may include any one of the twenty-ninth through forty-seventh aspects, further comprising curing the coated glass article at a curing temperature for a cure time. Curing temperature and cure time may be sufficient to remove diluent and cure the polymer coating material to produce the coating on the surface of the glass article.

A forty-ninth aspect of the present disclosure may include the forty-eighth aspect, comprising curing the coated glass article at a temperature of from 300° C. to 400° C., or 360° C., for a cure time of from 1 minute to 30 minutes, or 15 minutes.

A fiftieth aspect of the present disclosure may include any one of the twenty-ninth through forty-ninth aspects, further comprising drying the glass article after forming the adhesion promoting layer and before applying the coating.

A fifty-first aspect of the present disclosure may include the fiftieth aspect, wherein drying may comprise maintaining the glass article at a first drying temperature of from 45° C. to 95° C., or 65° C., for a period of from 1 hour to 48 hours, or 24 hours, and then maintaining the glass articles at a second drying temperature greater than the first drying temperature for a second time period of from 1 hour to 48 hours, wherein the second drying temperature may be in a range of 100° C. to 350° C., or 120° C.

A fifty-second aspect of the present disclosure may include any one of the twenty-ninth through fifty-first aspects, wherein the glass article may be a glass container and the surface of the glass article is an exterior surface of the glass container.

A fifty-third aspect of the present disclosure may include any one of the twenty-ninth through fifty-second aspects, wherein the method does not include a glass strengthening step after forming the adhesion promoting region or between forming the adhesion promoting region and applying the coating.

Additional features and advantages of the coated glass articles and the methods for making the coated glass articles will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross sectional view of a glass article having an adhesion promoting region at a surface of the glass article and a coating, according to one or more embodiments shown and described herein;

FIG. 2 schematically depicts an enlarged cross-sectional view of a portion of the glass article of FIG. 1, according to one or more embodiments shown and described herein;

FIG. 3 graphically depicts a table of coating materials of the coating on the surface of the glass article in FIG. 1, according to one or more embodiments shown and described herein;

FIG. 4 schematically depicts a testing jig for determining the coefficient of friction between two surfaces, according to one or more embodiments shown and described herein;

FIG. 5A is an atomic force microscopy (AFM) image of a surface of a glass container before etching the surface of the glass container, according to one or more embodiments shown and described herein;

FIG. 5B is an AFM image of a surface of a glass container after etching the surface of the glass container, according to one or more embodiments shown and described herein;

FIG. 6A graphically depicts Coefficient of Friction (COF) (y-axis) as a function of position along the glass vial (x-axis) for modified (adhesion promoting region) and coated glass vials of Example 3A and unmodified (no adhesion promoting region) coated glass vials of Comparative Example 4A, according to one or more embodiments shown and described herein;

FIG. 6B graphically depicts Coefficient of Friction (COF) (y-axis) as a function of position along the glass vial (x-axis) for modified (adhesion promoting region) and coated glass vials of Example 3B and unmodified (no adhesion promoting region) coated glass vials of Comparative Example 4B, according to one or more embodiments shown and described herein;

FIG. 6C graphically depicts Coefficient of Friction (COF) (y-axis) as a function of position along the glass vial (x-axis) for modified (adhesion promoting region) and coated glass vials of Example 3C and unmodified (no adhesion promoting region) coated glass vials of Comparative Example 4C, according to one or more embodiments shown and described herein;

FIG. 7 are images of abraded surfaces of untreated and uncoated glass vials of Sample 4D of Comparative Example 4, following COF testing, according to one or more embodiments shown and described herein;

FIG. 8 are images of abraded surfaces of the treated and coated glass vials of Sample 3A of Example 3, following COF testing, according to one or more embodiments shown and described herein;

FIG. 9 are images of abraded surfaces of the treated and coated glass vials of Sample 3B of Example 3, following COF testing, according to one or more embodiments shown and described herein;

FIG. 10 are images of abraded surfaces of the treated and coated glass vials of Sample 3C of Example 3, following COF testing, according to one or more embodiments shown and described herein; and

FIG. 11 graphically depicts refractive index (y-axis) as a function of wavelength of incident light (x-axis) for an uncoated glass vial and glass vials coated with various coatings, according to one or more embodiments shown and described herein.

### DETAILED DESCRIPTION

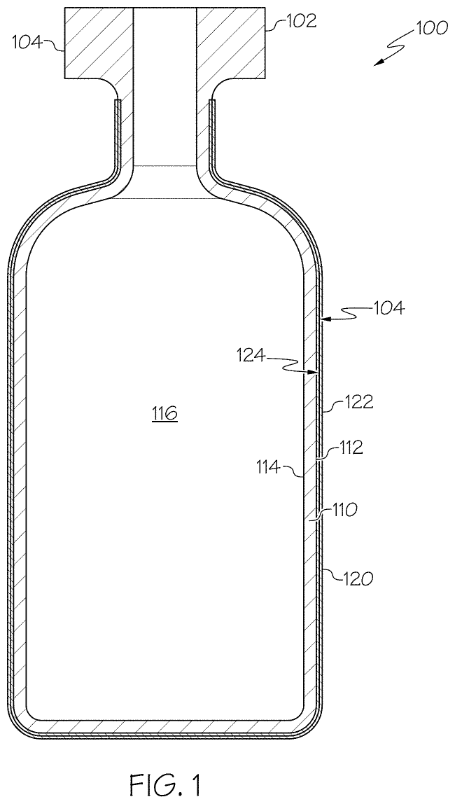

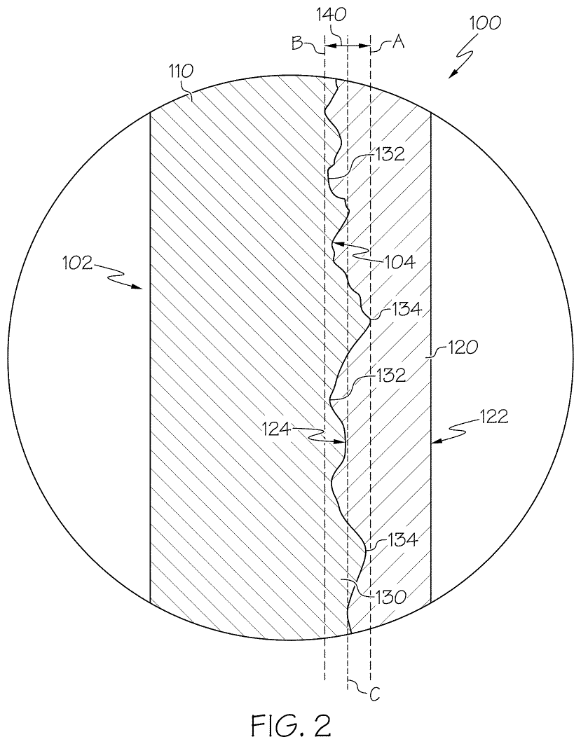

Reference will now be made in detail to various embodiments coated glass articles and methods for producing the same, examples of which are schematically depicted in the figures. Such coated glass articles may be glass containers suitable for use in various packaging applications including, without limitation, as pharmaceutical packages. It should be understood that coated glass articles may refer to coated pharmaceutical packages as described in this disclosure but is not intended to be limited thereto. Referring to FIGS. 1 and 2, one example of a coated glass article 100 is schematically depicted. The coated glass article 100 comprises a glass article 102 comprising a glass having a surface. The surface of the glass article 102 has an adhesion promoting region comprising a nanostructure formed at the surface of the glass. The nanostructure of the adhesion promoting region may comprise materials that are the same as one or more constituents of a glass composition of the glass. The coated glass article 100 further includes a coating 120 disposed on the adhesion promoting region formed at the surface of the glass. The coating 120 may include at least one polymer coating material.

The coated glass articles 100 may be prepared by a method that includes providing the glass article 102 comprising a glass having a surface and forming an adhesion promoting region at the surface of the glass article 102. The adhesion promoting region may be formed by treating one or more surfaces of the glass article 102 with an aqueous treating medium to remove material from the surface of the glass to form the nanostructure comprising a series of peaks and valleys that increase the surface area of the surface of the glass article 102. The nanostructure of the adhesion promoting region may comprise materials that are the same as constituents of the glass. After forming the adhesion promotion region at the surface, the method may further include applying the coating 120 to the adhesion promoting region to produce the coated glass article 100. The coating 120 may comprise a polymer coating material.

The methods disclosed herein include treating the surface of the glass article 102 to produce the adhesion promoting region before application of the coating. This method decouples formation of the nanostructure of the adhesion promoting region from application of the coating, which may enable single component polymer coating materials with advantaged performance attributes to be utilized. The methods disclosed herein may also eliminate the use of metal oxides, such as titania, from the coating material, which may reduce the changes to the optical properties of the coated glass articles caused by the titania or other transition metal oxides. The coating and the adhesion promoting region do not include a metal oxides, such as titanium dioxide (titania). Thus, the methods disclosed herein produce coated glass articles, such as coated glass containers, having a coating formulation that exhibits mechanical and thermal performance at least equivalent to existing coatings and that mitigates undesirable effects of titania or other transition metal oxides incorporated into coating materials to increase adhesion. The coated glass articles described herein may sufficiently retain their low coefficient of friction following a thermal treatment and may not substantially yellow in color following such a thermal treatment.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

Directional terms as used herein—for example up, down, right, left, front, back, top, bottom—are made only with reference to the figures as drawn and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, terms such as “container” and “vessel” refer to any article that is adapted to hold a solid or fluid for storage.

Historically, glass has been used as the preferred material for packaging pharmaceuticals because of its hermeticity, optical clarity, and excellent chemical durability relative to other materials. Specifically, the glass used in pharmaceutical packaging must have adequate chemical durability so as not to affect the stability of the pharmaceutical compositions contained therein. Glasses having suitable chemical durability include those glass compositions within the ASTM standard ‘Type 1B’ which have a proven history of chemical durability. However, use of glass for such applications is limited by the mechanical performance of the glass. In the pharmaceutical industry, glass breakage is a safety concern for the end user, as the broken package and/or the contents of the package may injure the end user. Further, non-catastrophic breakage (i.e., when the glass cracks but does not break) may cause the contents to lose their sterility which, in turn, may result in costly product recalls.

Specifically, the high processing speeds utilized in the manufacture and filling of glass pharmaceutical packages may result in mechanical damage on the surface of the package, such as abrasions, as the packages come into contact with processing equipment, handling equipment, and/or other packages. This mechanical damage significantly decreases the strength of the glass pharmaceutical package resulting in an increased likelihood that cracks will develop in the glass, potentially compromising the sterility of the pharmaceutical contained in the package or causing the complete failure of the package.

One approach to improving the mechanical durability of the glass package is to thermally and/or chemically temper the glass package. Thermal tempering strengthens glass by inducing a surface compressive stress during rapid cooling after forming. This technique works well for glass articles with flat geometries (such as windows), glass articles with thicknesses greater than about 2 mm, and glass compositions with high thermal expansion. However, pharmaceutical glass packages typically have complex geometries (vial, tubular, ampoule, etc.), thin walls (sometimes between about 1-1.5 mm), and are produced from low expansion glasses, making glass pharmaceutical packages commercially unsuitable for strengthening by conventional thermal tempering. Chemical tempering also strengthens glass by the introduction of surface compressive stress. The stress is introduced by submerging the article in a molten salt bath. As ions from the glass are replaced by larger ions from the molten salt, a compressive stress is induced in the surface of the glass. The advantage of chemical tempering is that it can be used on complex geometries, thin samples, and is relatively insensitive to the thermal expansion characteristics of the glass substrate.

However, while the aforementioned tempering techniques improve the ability of the strengthened glass to withstand blunt impacts, these techniques are less effective in improving the resistance of the glass to abrasions, such as scratches, which may occur during manufacturing, shipping and handling. Accordingly, ongoing needs exist for alternative glass articles which have improved resistance to mechanical damage.

Lubricous coatings applied to glass articles, such as pharmaceutical glass articles and containers or other glass articles, are selected to provide performance attributes of exceptional mechanical and thermal stability, environmental insensitivity, and negligible impact on the optical properties of the glass article. This demanding combination of properties arises from the need to preserve the structural integrity of the glass articles, such as glass containers, while they are being processed, such as by being filled on a filling line. In the absence of a coating, frictive contact between the external surfaces of glass articles introduces two undesirable effects: (1) flaws, which can weaken the glass, and (2) particles, which can compromise the internal contents filled into the glass articles, such as glass containers. During processing, a glass article, such as a glass container or other article, can also be exposed to depyrogenating or sterilizing (high temperatures or pressurized steam, respectively) environments or lyophilization conditions. Finally, when the glass article is a glass container, optical inspection of the glass container or contents of the glass container is often employed to validate the filling process. Any coating formulation must survive all of the processing steps while performing the function of protecting the glass of the glass article without impeding the ability to inspect the integrity of the glass article, and/or its contents.

Polymer coatings, such as fluorinated polyimide (PI) coatings, can provide a lubricous coating that reduces the article-to-article coefficient of friction to reduce damage to the glass articles during processing. However, single component polymer solutions comprising these fluorinated polyimides and no other adhesion promoting additives can exhibit reduced adhesion of the coating to silicate-based glass compositions. In order to improve the adhesion of the polyimide polymers to the surfaces of the glass, existing coating formulations include one or more secondary materials added to the coating formulation, where the secondary materials act as adhesion promoters. In particular, many existing coating formulations are binary composite coatings that include titania (TiO₂) in combination with the fluorinated polyimides, where the titania is included to improve adhesion of the fluorinated polyimide polymers to the surface of the glass articles. The underlying mechanism is an expansion of the contact area between the glass article and the polyimide coating material. When incorporated into the coating formulation, titania forms a high surface area nanoporous-structured substrate with excellent adhesion to silica. While combining titania with the fluorinated polyimide polymers may produce a coating that satisfies the mechanical and thermal property requirements, the titania enhances the environmental sensitivity of the coating materials and changes the optical properties of the glass, such as by introducing undesirable light scattering by the coated glass article. The change in optical properties of the coated glass articles, in particular the increased light scattering, may make optical inspection of the coated glass articles and/or the contents contained therein more difficult.

The present disclosure is directed to coated glass articles, such as but not limited to coated glass vials or other pharmaceutical containers, that include a coating formulation whose mechanical and thermal performance is at least equivalent to existing coatings comprising titania while mitigating the undesirable effects of titania and other materials that adversely change the optical properties of the coated glass articles. Adhesion promotion in the present disclosure is still achieved by expansion of the contact surface area between the glass article and a polyimide coating material. However, instead of including titania in the coating formulation, an adhesion promoting region comprising a high-surface area nanoporous structure is fabricated from the parent glass of the glass article by exposure to an aqueous treating medium prior to the application of the coating. The exposure of the surface of the glass article to the aqueous treating medium may remove constituents of the glass to form a nanostructure in the surface of the glass article. The nanostructure of the adhesion promoting region may increase the surface area of the adhesion promoting region compared to the glass before the formation of the nanostructure. The adhesion promoting region, and the increased surface area thereof, may improve adhesion of the coating to the glass while eliminating the use of titania in the coating materials and reducing the optical problems associated with the presence of the titania at the surface of the glass article.

Various embodiments of the coatings, glass articles with coatings, and methods for forming the same will be described in further detail herein with specific reference to the appended drawings. While embodiments of the coatings described herein are described in the context of application of the coating to the outer surface of a glass container, it should be understood that the coatings and methods disclosed herein may be used to provide coatings on a wide variety of materials, including non-glass materials, and on articles other than containers including, without limitation, glass display panels and the like.

Generally, a coating may be applied to a surface of a glass article, such as a container that may be used as a pharmaceutical package or other type of glass article. The coating may provide advantageous properties to the coated glass article such as a reduced coefficient of friction and increased damage resistance. The reduced coefficient of friction may impart improved strength and durability to the glass article by mitigating frictive damage to the glass during handling and processing of the glass article. Further, the coating may maintain the aforementioned improved strength and durability characteristics following exposure to elevated temperatures and other conditions, such as those experienced during packaging and pre-packaging steps utilized in packaging pharmaceuticals, such as, for example, depyrogenation, lyophilization, autoclaving, and the like. Accordingly, the coatings and coated glass articles with the coating may be thermally stable.

FIG. 1 schematically depicts a cross-section of a coated glass article 100, specifically a coated glass container. The coated glass article 100 comprises a glass article 102 having a surface 104 and a coating 120 applied to the surface 104. In embodiments, the glass article 102 may be a glass container that may include a glass wall 110 extending between an exterior surface 112 (i.e., a first surface) and an interior surface 114 (i.e., a second surface). The interior surface 114 of the glass wall 110 may define an interior volume 116 of the glass article 102. The surface 104 of the glass article 102 may be the exterior surface 112, the interior surface 114, or both of the glass article 102 when the glass article 102 is a glass container. The coating 120 is positioned on at least one surface 104 of the glass article 102, such as but not limited to the exterior surface 112, the interior surface 114, or both of the glass article 102 to form the coated glass article 100. In embodiments, the coating 120 is positioned on the exterior surface 112 of the glass article 102 to form the coated glass article 100. As used herein, a coating may be “positioned on” a substrate while not in direct contact with the substrate, such as if an intermediate layer is present between the substrate and a coating positioned over that substrate. In embodiments, the coating 120 may be positioned on substantially the entire exterior surface 112 of the glass article 102. In embodiments, such as the embodiment depicted in FIG. 1, the coating 120 may be bonded to the glass article 102 at the exterior surface 112 of the glass article 102. The coating 120 has an outer surface 122 and a glass contacting surface 124 at an interface of the surface 104 of the glass article 102 and the coating 120. In embodiments, the glass article 102 is a glass container comprising an exterior surface 112 and an interior surface 114, wherein the exterior surface 112 is the surface comprising the adhesion promoting region and the coating 120.

In embodiments, the coated glass article 100 is a pharmaceutical package, such as but not limited to a pharmaceutical container. For example, the glass article 102 may be in the shape of a vial, ampoule, cartridge, bottle, flask, phial, beaker, bucket, carafe, vat, syringe body, jar, or the like. The coated glass article 100 may be a container used for containing any composition, and in embodiments, may be used for containing a pharmaceutical composition. The coated glass article 100 may be a container for holding sterile substances, such as but not limited to vaccines, biologics, pharmaceutical compositions, foodstuffs, solutions, or the like. A pharmaceutical composition may include any chemical substance intended for use in the medical diagnosis, cure, treatment, or prevention of disease. Examples of pharmaceutical compositions include, but are not limited to, medicines, drugs, medications, medicaments, remedies, and the like. The pharmaceutical composition may be in the form of a liquid, solid, gel, suspension, powder, or the like.

The glass articles 102 to which the coating 120 may be applied may be formed from a variety of different glass compositions. The specific composition of the glass article 102 may be selected according to the specific application such that the glass has a desired set of physical properties. In embodiments, the glass of the glass article 102 may be a glass composition that is known to exhibit chemical durability and low thermal expansion, such as but not limited to alkali borosilicate glasses. According to embodiments, the glass article 102 may be formed from a Type I, Class B glass according to ASTM Standard E438-92.

The glass articles 102 may be formed from a glass composition that has a coefficient of thermal expansion in the range from about 25×10⁻⁷/° C. to 80×10⁻⁷/° C. For example, in embodiments, the glass article 102 is formed from alkali aluminosilicate glass compositions, which can be easily strengthened through ion-exchange. Such glass compositions generally may include a combination of SiO₂, Al₂O₃, at least one alkaline earth oxide, and one or more alkali oxides, such as Na₂O and/or K₂O. In embodiments, the glass composition may be free from boron and compounds containing boron. In embodiments, the glass compositions may further comprise minor amounts of one or more additional oxides such as, for example, SnO₂, ZrO₂, ZnO, TiO₂, As₂O₃, or the like. Minor amounts may include amounts less than 5 weight percent (mol. %), less than 2 mol. %, or even less than 1 mol. %. These additional oxide constituents may be added as fining agents and/or to further enhance the chemical durability of the glass composition.

In embodiments, the glass article 102 can be strengthened such as by ion-exchange strengthening. Glass strengthened by ion-exchange may be referred to herein as “ion-exchanged glass.” For example, the glass article 102 may have a compressive stress of greater than or equal to about 300 MPa or even greater than or equal to about 350 MPa. In some embodiments, the compressive stress may be in a range from about 300 MPa to about 900 MPa. However, it should be understood that, in some embodiments, the compressive stress in the glass may be less than 300 MPa or greater than 900 MPa. In embodiments, the glass body 102 may have a depth of layer greater than or equal to 20 μm. In some of these embodiments, the depth of layer may be greater than 50 μm or even greater than or equal to 75 μm. In still other embodiments, the depth of the layer may be up to or greater than 100 μm.

The ion-exchange strengthening may be performed in a molten salt bath maintained at temperatures from about 350° C. to about 500° C. To achieve the desired compressive stress, the glass article 102 (uncoated) may be immersed in the salt bath for less than about 30 hours or even less than about 20 hours. For example, in one embodiment, the glass article 102 is immersed in a 100% KNO₃ salt bath at 450° C. for about 8 hours.

In one particularly exemplary embodiment, the glass article 102 may be formed from an ion-exchangeable glass composition described in pending U.S. patent application Ser. No. 13/660,450 filed Oct. 25, 2012 and entitled “Glass Compositions with Improved Chemical and Mechanical Durability” assigned to Corning, Incorporated (granted as U.S. Pat. No. 8,980,777). However, it should be understood that the coated glass articles 100 described herein may be formed from other glass compositions including, without limitation, ion-exchangeable glass compositions and non-ion exchangeable glass compositions. For example, in embodiments, the glass article 102 may be formed from borosilicate glass. In embodiment, the glass article 102 may be formed from Type 1B glass compositions such as, for example, Schott Type 1B borosilicate glass. In embodiments, the glass article 102 may be formed from ion-exchangeable borosilicate glass composition, such as those described in co-pending U.S. application Ser. No. 16/533,954, filed Aug. 7, 2019 and entitled “Ion Exchangeable Borosilicate Glass Compositions and Glass Articles Formed from the Same” assigned to Corning Incorporated.

In embodiments described herein, the glass article 102 may be formed from a glass composition which meets the criteria for pharmaceutical glasses described by regulatory agencies such as the USP (United States Pharmacopoeia), the EP (European Pharmacopeia), and/or the JP (Japanese Pharmacopeia) based on their hydrolytic resistance. Per USP 660 and EP 7, borosilicate glasses meet the Type I criteria and are routinely used for parenteral packaging. Examples of borosilicate glass include, but are not limited to, Corning® Pyrex® 7740, 7800 and Wheaton 180, 200, and 400, Schott Duran, Schott Fiolax, KIMAX® N-51A, Gerrescheimer GX-51 Flint and others. Soda-lime glass meets the Type III criteria and is acceptable in packaging of dry powders which are subsequently dissolved to make solutions or buffers. Type III glasses are also suitable for packaging liquid formulations that prove to be insensitive to alkali. Examples of Type III soda lime glass include Wheaton 800 and 900. De-alkalized soda-lime glasses have higher levels of sodium hydroxide and calcium oxide and meet the Type II criteria. These glasses are less resistant to leaching than Type I glasses but more resistant than Type III glasses. Type II glasses can be used for products that remain below a pH of 7 for their shelf life. Examples include ammonium sulfate treated soda lime glasses. These pharmaceutical glasses have varied chemical compositions and have a coefficient of linear thermal expansion (CTE) in the range of 20-85×10⁻⁷/° C.

In embodiments, the glass comprises a glass composition that meets the criteria for pharmaceutical glasses described in United States Pharmacopoeia (USP) 600 or European Pharmacopoeia 7. In embodiments, the glass composition of the glass article 102 may be a silicate glass, an aluminosilicate glass, an alkali aluminosilicate glass, an ion-exchanged aluminosilicate glass, an ion-exchanged alkali aluminosilicate glass, a borosilicate glass, an ion-exchanged borosilicate glass, a soda lime glass, or combinations of these.

When the coated glass articles 100 described herein are glass containers, the glass article 102 of the coated glass containers may take on a variety of different forms. For example, the glass articles described herein may be used to form coated glass containers such as vials, ampoules, cartridges, syringe bodies, bottle, flask, phial, beaker, bucket, carafe, vat, jar, and/or any other glass container for storing, preparing, and/or administering pharmaceutical compositions. Moreover, the ability to chemically strengthen the glass containers prior to coating can be utilized to further improve the mechanical durability of the glass containers. Accordingly, it should be understood that, in at least one embodiment, the glass containers may be ion-exchange strengthened prior to formation of the adhesion promoting region and application of the coating. Alternatively, other strengthening methods such as heat tempering, flame polishing, and laminating, as described in U.S. Pat. No. 7,201,965, could be used to strengthen the glass before forming the adhesion promoting region and coating the glass article.

Referring again to FIG. 1, the surface 104 of the glass article 102 includes an adhesion promoting region comprising a nanostructure formed into the surface 104 of the glass. In embodiments, the glass article 102 may be a glass container comprising an exterior surface 112 and an interior surface 114, and the exterior surface 112 may be the surface comprising the adhesion promoting region and the coating. The adhesion promoting region may have an increased surface area compared to surfaces of the glass article 102 without the adhesion promoting region. The increased surface area improves adhesion of the coatings to the surface 104 of the glass article 102.

Referring now to FIG. 2, a magnified view of a cross-section of a portion of the coated glass article 100 is schematically depicted. The coated glass article 100 comprises the glass article 102 and the adhesion promoting region 130 formed into the surface 104 of the glass article 102. The adhesion promoting region 130 may comprise a nanostructure formed into the surface 104 of the glass article 102. The nanostructure of the adhesion promoting region 130 may comprise a plurality of recesses 132 (valleys) and a plurality of protrusions 134 distributed across the surface 104 of the glass article 102 in the adhesion promoting region 130. In other words, the adhesion promoting region 130 may include a nanostructure having a topography comprising peaks and valleys distributed across the surface of the glass article 102.

The nanostructure of the adhesion promoting region 130 may be formed from materials that are the same as one or more constituents of the glass composition of the glass article 102. In particular, the nanostructure of the adhesion promoting region 130 may be formed from materials that are major constituents of the glass composition of the glass article 102. In embodiments, the nanostructure of the adhesion promoting region 130 may comprise one or more constituents of the glass that are present in amounts greater than or equal to 1 mol. %, greater than or equal to 2 mol. %, or even greater than or equal to 5 mol. % in the glass composition of the glass article 102 prior to formation of the adhesion promoting region 130. The nanostructure of the adhesion promoting region may comprise one or more of silica, alumina, alkali metal oxides, boron compounds, or combinations of these. In embodiments, the nanostructure of the adhesion promoting region 130 is substantially free of transition metal oxides, such as titanium dioxide (titania). In embodiments, the nanostructure of the adhesion promoting region 130 comprises less than 5 mol. %, less than 1 mol. %, or even less than or equal to 0.1 mol. % transition metal oxides, such as titania, based on the unit weight of the glass comprising the nanostructure of the adhesion promoting region 130. In embodiments, the nanostructure of the adhesion promoting region does not include titanium dioxide and/or other constituents that have a substantial influence on the optical properties of the coated glass article 100 compared to uncoated glass articles of the same glass composition.

The nanostructure of the adhesion promoting region 130 may be formed by contacting the surface 104 of the glass article 102 with an aqueous treating medium. The aqueous treating medium may be a low fluoride content aqueous solution of ammonium bifluoride and citric acid. Contacting the surface 104 of the glass article 102 with the aqueous treating medium may selectively remove materials from the surface 104 of the glass article 102 to form the nanoporous structure of the adhesion promoting region 130 in the surface 104 of the glass article 102.

The aqueous treating medium may be an aqueous composition capable of dissolving one or more constituents of the glass composition from the surface 104 of the glass article 102. As previously discussed, the glass articles 102 are generally formed from glass compositions that include silica (SiO₂) as the primary network former in combination with additional constituent components (e.g., B₂O₃, alkali oxides, alkaline earth oxides, and the like), which are present in the silica network. However, the silica and the other constituent components are not necessarily soluble in the same solutions or dissolve at the same rate in a given aqueous solution. Accordingly, the aqueous treating medium may include fluoride ions and/or one or more acids to facilitate uneven dissolution of constituents from the glass to form the nanostructure comprising the adhesion promoting region 130 at the surface 104 of the glass article 102.

The aqueous treating medium comprises fluoride ions, one or more acids, or combinations of these. In embodiments, the aqueous treating medium comprises fluoride ions. When the aqueous treating medium comprises fluoride ions, a source of the fluoride ions may be selected from one or more than one of HF, NaF, NH₄HF₂, or the like. In embodiments that contain fluoride, the aqueous treating medium can include from 0.001 wt. % to 0.15 wt. % fluoride ions, such as from 0.001 wt. % to 0.12 wt. %, of from 0.001 wt. % to 0.10 wt. % fluoride ions based on the total weight of the aqueous treating medium.

In embodiments, the aqueous treating medium may comprise an acid so that the aqueous treating medium is an acidic aqueous treating medium. A variety of acidic compounds can be used, either alone or in combination, to formulate the acidic aqueous treating medium suitable for treating the surface of the glass articles 102 to produce the nanostructure of the adhesion promoting region 130 for the coated glass articles 100 disclosed herein. The aqueous treating medium may include a mineral acid, an organic acid, or combinations of these. In embodiments, the aqueous treating medium may include an organic acid that is a chelating organic acid. In embodiments, the aqueous treating medium may include an aqueous solution of the mineral acid, organic acid, or both. Suitable acids for the aqueous treating medium may include, but are not limited to, one or more of HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, mixtures thereof, and combinations comprising at least one of the foregoing. In embodiments, the aqueous treating medium may comprise at least one acid selected from the group consisting of HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations of these acids.

In embodiments, the aqueous treating medium comprises fluoride ions and an acid. In embodiments, the aqueous treating medium comprises an aqueous solution of ammonium bifluoride and citric acid. In embodiments, the aqueous treating medium may comprise from 0.026 molar (M) to 0.26 M ammonium bifluoride, or about 0.26 M ammonium bifluoride. In embodiments, the aqueous treating medium may comprise from 0.5 M to 2 M citric acid, or about 1.0 M citric acid. In embodiments, the aqueous treating medium may have a pH of less than or equal to 3, such as less than or equal to 2.5, less than or equal to 1, or even less than or equal to 0.5. In some embodiments, the aqueous treating medium may not be acidic or may be mildly acidic. For example, in embodiments, the aqueous treating medium may have a pH from 4 to 12, such as a pH from 6 to 12, from 6 to 10, or even from 8 to 10.

In embodiments, the composition of the aqueous treating medium may be substantially fluoride-free. The phrase “substantially fluoride-free,” as used herein, means that the aqueous treating medium may comprise less than or equal to 0.15 wt. % (i.e., 1500 parts per million by weight (ppmw)) fluoride ions based on the total weight of the aqueous treating medium. In embodiments, the aqueous treating medium may comprise less than or equal to 0.12 wt. % (i.e., 1200 ppmw) fluoride ions, such as less than or equal to 0.10 wt. % (i.e., 1000 ppmw), less than or equal to 0.095 wt. % (i.e., 950 ppmw), or even less than or equal to about 0.09 wt. % (i.e., 900 ppmw) fluoride ions, based on the total weight of the aqueous treating medium. In some embodiments, the aqueous treating medium can have no fluoride ions. A variety of compounds can be used, either alone or in combination, to formulate a substantially fluoride-free aqueous treating medium suitable for forming the nanostructure of the adhesion promoting region 130 in the surface 104 of the glass article 102. In embodiments, the aqueous treating medium may be an aqueous solution comprising water and fluoride ions. In embodiments, the substantially fluoride-free aqueous treating medium may be an aqueous solution comprising basic components such as NH₃, or alkali hydroxides (such as, for example, NaOH, KOH, LiOH), or alkaline earth metal hydroxides (such as, for example, Ca(OH)₂ or Ba(OH)₂).

To selectively remove constituents of the glass composition to form the nanostructure of the adhesion promoting region 130 in the surface 104 of the glass article 102, the surface 104 of the glass article 102 may be contacted with the aqueous treating medium. In other words, forming the nanostructure of the adhesion promoting region 130 may include contacting the surface 104 of the glass article 102 with the aqueous treating medium. The step of contacting the surface 104 of the glass article 102 with the aqueous treating medium can be implemented by a variety of techniques, including spraying the aqueous treating medium onto the surface 104 of the glass article 102, partially or completely immersing the glass article 102 in a vessel that comprises the aqueous treating medium, or other like techniques for applying a liquid to a solid surface.

In the embodiments described herein, it should be understood that processing conditions may affect the etch rate of glass (e.g., rate of dissolution of constituents from the glass) in the aqueous treating medium and may be adjusted to control the rate of dissolution of one or more constituents from the glass. For example, the temperature of the aqueous treating medium and/or glass article 102 may be increased to increase the dissolution rate of constituents of the glass in the aqueous treating medium, thereby decreasing processing time. Alternatively, the concentration of active constituents (e.g., acids, fluoride ions, etc.) in the aqueous treating medium may be increased to increase the dissolution rate of constituents of the glass in the aqueous treating medium, thereby decreasing processing time. The surface 104 of the glass article 102 may be contacted with the aqueous treating medium at a temperature and for a contact time sufficient to remove constituents from the glass to form the nanostructure of the adhesion promoting region 130 in the surface 104 of the glass article 102. In embodiments, the surface 104 of the glass article 102 may be contacted with the aqueous treating medium at a temperature of from 0° C. to 105° C., such as from 20° C. to 100° C. or even from 45° C. to 100° C., and for a contact time of from 5 minutes to 48 hours, such as from 5 minutes to 24 hours, from 5 minutes to 12 hours, from 5 minutes to 1 hour, or for about 30 minutes.

In embodiments, forming the adhesion promoting region 130 on the surface 104 of the glass article 102 may include leaching low durability constituents from the glass at the surface 104 of the glass before contacting the surface of the glass article 102 with the aqueous treatment medium. Leaching may include contacting the surface of the glass article 102 with a strong acid at a temperature of from 45° C. to 105° C. for a duration sufficient to remove low durability components from the glass to form the nanoporous structure in the first surface of the glass article. The strong acid may include but is not limited to hydrochloric acid, sulphuric acid, nitric acid, hydrobromic acid, hydroiodic acid, perchloric acid, chloric acid, or combinations of these. In embodiments, the strong acid is hydrochloric acid. The strong acid may comprise an aqueous acid solution comprising a concentration of the strong acid of from 0.001 molar (M) to 12 M, or about 0.15 M. In embodiments, the method of forming the adhesion promoting region 130 on the surface of the glass article 102 does not include leaching low durability constituents from the surface 104 of the glass article 102.

After forming the adhesion promoting region 130, the glass article 102 having the adhesion promoting region 130 may be dried prior to application of the coating 120. In embodiments, the methods for making the coated glass articles 100 may further include drying the glass article 102 after forming the adhesion promoting layer 130 and before applying the polymer coating material. Drying may include maintaining the glass article 102 at a drying temperature for a drying time period, where the drying temperature and drying time are sufficient to remove water or other solvents from the adhesion promoting region 130 of the surface 104 of the glass article 102. In embodiments, drying may include a two stage drying process that comprises maintaining the glass article 102 at a first drying temperature of from 45° C. to 95° C., or 65° C., for a first drying time period of from 1 hour to 48 hours, or 24 hours, and then maintaining the glass articles 102 at a second drying temperature greater than the first drying temperature for a second drying time period of from 1 hour to 48 hours, wherein the second drying temperature in a range of from 100° C. to 350° C., or 120° C. The drying may remove any moisture from the surface 104 of the glass prior to applying the coating material to the surface of the glass article 102.

The adhesion promoting region 130 may have a surface area that is greater than the surface area of the glass article 102 prior to forming the adhesion promoting region 130. The greater surface area of the adhesion promoting region 130 may increase the contact area between the coating material and the glass during the coating process, which may increase adhesion of the coating materials to the glass. The adhesion promoting region 130 may have a glass surface area of greater than or equal to 2 times the surface area of the surface 104 of the glass article 102 without the adhesion promoting region 130. In embodiments, the adhesion promoting region 130 may have a glass surface area of greater than or equal to 1.05 times, greater than or equal to 2 times, greater than or equal to 5 times, or even greater than or equal to 10 times the surface area of the surface 104 of the glass article 102 without the adhesion promoting region 130.

The increase in surface area of the adhesion promoting region 130 may be characterize by an increase in average surface roughness of the glass compared to the glass without the adhesion promoting region 130. The adhesion promoting region 130 may have a greater average surface roughness (Ra) compared to the glass surface without the adhesion promoting region 130. In embodiments, the adhesion promoting region 130 may have an average surface roughness (Ra) of greater than or equal to 0.3 nanometers (nm), such as greater than or equal to 0.4 nm, or even greater than or equal to 0.5 nm. The adhesion promoting region 130 may have a surface roughness Ra value of from 0.3 nm to 130 nm or from 0.4 nm to 130 nm. The surface roughness Ra value of the adhesion promoting region 130 may be determined using an interferometer in accordance with known testing methods.

The adhesion promoting region 130 formed on the surface 104 of the glass article 102 may be optically inert. As used herein, the term “optically inert” refers to a feature, such as the adhesion promoting region 130, coating 120, or other feature, producing a minimal change in the optical properties of the glass, such as a change of less than 10%, less than 5%, or even less than 3% of an optical property of the glass. The optical properties of the glass may include but are not limited to a refractive index of the glass. In embodiments, the adhesion promoting region 130 formed on the surface 104 of the glass article 102 may have a refractive index that is within 10%, within 5%, or even within 3% of a refractive index of the glass article 102 without the adhesion promoting region 130 or the coating 120. The refractive index of the adhesion promoting region 130 and/or the coating may be determined using a refractometer.

The optical properties of the adhesion promoting region 130 may be evaluated by imaging the glass article 102 having the adhesion promoting region 130 using a Pegasus® imaging system, available from Accusoft® Corporation, and determining a Pegasus Number from the image data. The Pegasus Number is indicative of the optical response of the glass article 102. The glass article 102 without the adhesion promoting region 130 or the coating may have a Pegasus Number of 32. The glass article 102 having the adhesion promoting region 130 on the surface 104 of the glass article 102 may have a Pegasus Number of within 10%, within 5%, or even within 3% of the Pegasus Number of the glass article 102 without the adhesion promoting region 130 or the coating 120.

Referring again to FIG. 2, the adhesion promoting region 130 may have a thickness sufficient for the peaks 134 and valleys 132 of the nanostructure to provide increased surface area to improve adhesion of the coating materials to the surface 104 of the glass article 120 to form the coating 120. The thickness of the adhesion promoting region 130 may be a distance between the highest peak of the nanostructure (represented by Line A in FIG. 2) and the lowest valley of the nanostructure (represented by Line B in FIG. 2) in a direction perpendicular to the surface of the glass. In other words, the thickness of the adhesion promoting region 130 may be the distance between Line A and Line B in FIG. 2 in a direction perpendicular to Lines A and B. The adhesion promoting region 130 may have a thickness of from 5 nm to 2 μm, such as from 5 nm to 1 μm, from 5 nm to 0.5 μm, from 10 nm to 2 μm, from 10 nm to 1 μm, from 10 nm to 0.5 μm, from 100 nm to 2 μm, from 100 nm to 1 μm, of even from 100 nm to 0.5 μm.

In embodiments, the glass article may comprise a coating 120 applied to the glass article 102 to produce the coated glass article 100. Following formation of the adhesion promoting region 130 on the glass article 102, the coating 120 may be formed on the glass article 102 to produce the coated glass article 100. The coating 120 may be formed by applying a coating material to the adhesion promoting region 130 of the glass article 102. The coating material may be a polymer coating material, a non-polymer coating material, or combinations of these. In embodiments, the coating material may include a polymer coating material. In embodiments, the coating material may be a friction reducing coating. In embodiments, the coating material may be a single component coating.

Referring again to FIGS. 1 and 2, the coating 120 may comprise a single-layered structure sometimes referred to herein as a “mono-layer” structure. For example, the coating 120 may have a substantially homogenous composition of one or more coating materials. In other embodiments, the coating 120 may be mixed but not fully homogenous. For example, in embodiments, one or more chemical constituents of the mixture may congregate at an interface of the coating 120 (e.g., the interface with the glass article 102 or the outer surface 122). In such an embodiment, the local concentration of a chemical constituent may differ over different areas of the coating 120. However, it should be understood that the term “mixed” as used herein refers to layers that have at least some dispersion of at least two chemical components, and includes layers that are not fully homogenous. Generally, a mixed layer is deposited as a mixture of two or more chemical constituents contained in a coating mixture.

In embodiments, the coating 120 may comprise at least one polymer coating material. In general, the polymer coating material comprises one or a plurality of polymers that are thermally stable polymers that will not degrade significantly or at all when exposed to temperatures suitable for depyrogenation, such as temperature of at least 250° C., at least 260° C., at least 280° C., or even at least 300° C. for 30 minutes or more. The coating 120 may be applied to a glass article 102 in a coating mixture or coating solution comprising one or more polymers or polymer precursors. The “coating mixture” refers to the liquid solution which contains the polymers and/or polymer precursors and which is applied to the surface 103 of the glass article 102. Usually, the coating mixture will include one or more solvents, such as one or more organic solvents, along with the polymer or polymer precursor. As used herein, a “polymer precursor” refers to a chemical constituent that contains material, which will become a constituent in the coating 120 following application to and curing of the coated glass article 100. That is, at least some of the atoms of the polymer precursor will become the atoms of the formed polymer coating. The polymer precursor may include non-completely polymerized or non-polymerized chemical constituents that partially or fully polymerize or otherwise react upon curing. For example a polyamic acid is considered a polymer precursor, as it imidizes to form a polyimide during curing. As used herein, a “non-completely polymerized” polymer precursor material may exist in a polymeric state, but may require further treatment to form particular polymeric bonding, such as imidization. Also, in embodiments, more than one polymer, polymer precursor, or both, may be included in the coating mixture.

As described hereinabove, coating 120 comprises a polymeric coating material comprising one or more polymers. In embodiments, the polymer of the coating may be any polymer or combination of polymers that do not substantially degrade at elevated temperatures such as at temperature of greater than or equal to 250° C., greater than or equal to 260° C., greater than or equal to 280° C., or even greater than or equal to 300° C. As used herein, a polymer does not “substantially degrade” if it has not lost at least about 5% of its mass. For example, a TGA test can be utilized to determine whether a polymer substantially degrades at a given temperature. It should be understood that the polymers should not substantially degrade in heat treatments following the initial curing, and curing treatments do not constitute heat treatments utilized for verifying thermal stability of a coating or material of a coating, such as a polyimide. For example, polymers that may be included in the coating 120 may include polyimides, fluoropolymers, fluorinated polyimides, and/or polyamide-imides.

In embodiments, the polymer may be a polyimide which is present in the coating mixture as a partially or fully imidized polyimide in a solution of an organic solvent. For example, some fluorinated polyimides that are soluble in organic solvents may be used. These fluorinated polyimides may be present in the coating mixture in an imidized state. The polyimides may be stable in organic solvents such as, but not limited to, N,N-Dimethylacetamide (DMAc), N,N-Dimethylformamide (DMF), and 1-Methyl-2-pyrrolidinone (NMP) solvents, or mixtures thereof.

In embodiments, the polymer may be formed from one or more than one polymer precursor. For example some polyimides may not be structurally stable in solution in polyimide form, and are instead present in solution as polyamic acids, which may be non-cylized polyimide precursors which may be formed from, for example, diamine monomers and dianhydride monomers. Generally, polyamic acids must be cured to become imidized chemical species. Such curing may comprise heating the polyamic acid at 300° C. for 30 minutes or less, or at a temperature higher than 300° C., such as at least 320° C., 340° C., 360° C., 380° C., or 400° C. It is contemplated that higher curing temperatures may be paired with shorter curing times. Without being bound by any particular theory, it is believed that the curing step imidizes a polyamic acid by reaction of carboxylic acid moieties and amide moieties to form a polyimide.

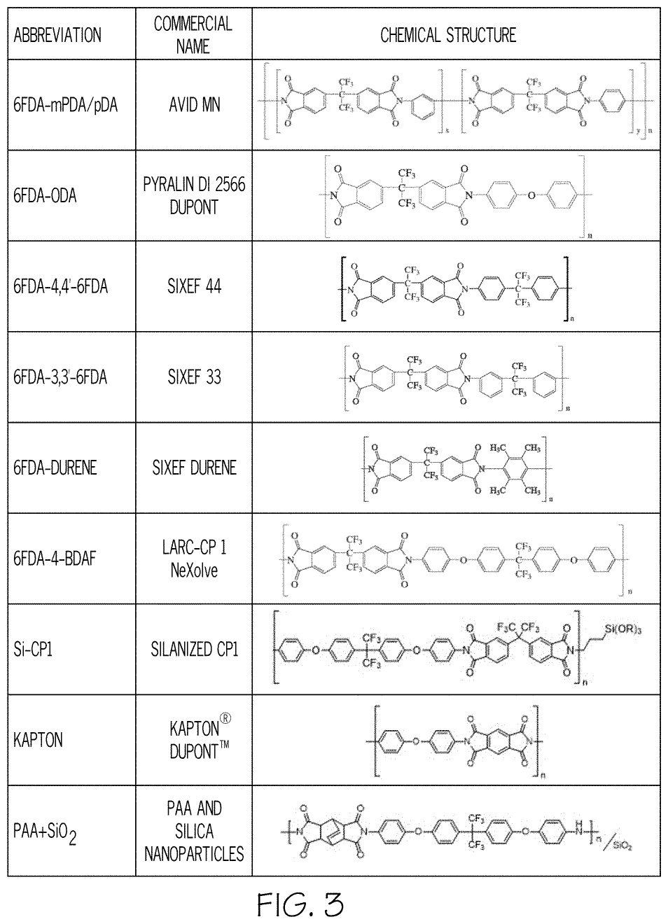

Examples of suitable fluorinated polyimides include the copolymers 2,2-bis(3,4-dicarboxyphenyl) hexafluoropropane dianhydride-co-1,4-phenylenediamine, 2,2-bis(3,4-dicarboxyphenyl) hexafluoropropane dianhydride-co-1,3-phenylenediamine; (abbreviated as 6FDA-mPDA/pPDA, commercially available as Avimid N from Cytec); 2,2-bis(3,4-dicarboxyphenyl) hexafluoropropane di anhydride-co-4,4′-oxydianiline (abbreviated as 6FDA-ODA, commercially available as Pyralin DI 2566 from DuPont); 2,2-bis(3,4-dicarboxyphenyl) hexafluoropropane dianhydride-co-1,4-phenylenediamine, 2,2-bis(3,4-dicarboxyphenyl) hexafluoropropane dianhydride-co-4,4′-(2,2,2-trifluoro(1-trifluoromethyl)ethylidene) bisbenzeneamine (abbreviated as 6FDA-4,4′-6F (commercially available as Sixef 44 from Hoechst Celanese); 2,2-bis(3,4-dicarboxyphenyl) hexafluoropropane di anhydride-co-1,4-phenylenediamine, 2,2-bis(3,4-dicarboxyphenyl) hexafluoropropane dianhydride-co-3,3′-(2,2,2-trifluoro(1-trifluoromethyl)ethylidene) bisbenzeneamine (abbreviated as 6FDA-3,3′-6F, commercially available as Sixef 33 from Hoechst Celanese); 2,2-bis(3,4-dicarboxyphenyl) hexafluoropropane dianhydride-co-2,3,5,6-tetramethylphenylene diamine (abbreviated as 6FDA-Durene, commercially available as Sixef Durene from Hoechst Celanese); and 2,2-bis(3,4-dicarboxyphenyl) hexafluoropropane dianhydride-co-2,2-bis[4-(4-aminophenoxy) phenyl]hexafluoropropane (abbreviated 6FDA-4-BDAF, commercially available as LARC-CP1 from NeXolve), silanized CP1, poly (4,4′-oxydiphenylene-pyromellitimide) (commercially available as Kapton® from DuPont™), other polyimide copolymers, or combinations of these. Chemical Structures for selected fluorinated polyimides are provided in FIG. 3.

In another embodiment, halogenated polyimide siloxanes may be utilized as the polymer component in the coating 120. Such halogenated polyimide siloxanes may be halogenated, such as fluorinated, and may comprise siloxane moieties. Examples of suitable halogenated polyimide siloxanes can be found in European Patent Application 15290254.0, entitled “Halogenated Polyimide Siloxane Chemical Compositions and Glass Articles with Halogenated Polyimide Siloxane Low-Friction Coatings,” which is incorporated by reference herein in its entirety. These halogenated polyimide siloxanes may be advantageous because they may be soluble in a partially or fully imidized form in a non-toxic and low boiling point solvent such as acetates or ketones (e.g., low boiling point solvents may include ethyl acetate, propyleneglycol methyl ether acetate, toluene, acetone, 2-butanone, and mixtures thereof).

The coating 120 may include one or more silicone-based coatings, silane-based coatings, inorganic coatings (e.g., siloxane-based coatings), particle-based coatings, or combinations of these. In embodiments, the coating 120 may include one or more silicone-based coatings. Examples of silicone-based coatings may include, but are not limited to DC366 dimethicone NF emulsion available from Dow Silicones Corporation, MED-361 silicone available from NuSil™ Technologies, MED-6670 low friction silicone coating available from NuSil™ Technologies, or other silicone-based coatings. In embodiments, the coating 120 may include one or more silane-based coatings, such as but not limited to fluorosilane coatings. In embodiments, the coating 120 may include one or more inorganic coatings, such as but not limited to siloxane-based coatings or oxide coatings. An example of a siloxane-based coating may include, but is not limited to a tetraethyl orthosilicate coating material. In embodiments, the coating 120 may include one or more particle-based materials, such as but not limited to TOSPEARL™ silicone resin microspheres available from Momentive Performance Materials.

In embodiments, the coating 120 may include one or more non-polymer constituents that do not change the optical properties of the coating. Examples of non-polymer constituents that do not change the optical properties of the coating may include but are not limited to silica or other constituents of the glass composition that are generally optically inert. The coating 120 may be a non-polymer coating, such as but not limited to a silicon oil or other non-polymer material.

In embodiments, the coating 120 may comprise the polymer coating material that is a single component coating material, meaning the polymer coating material comprises a single type of polymer or the reaction product of a single combination of polymer precursors, with the diluent or solvent not being considered as part of the polymer coating material. Thus, a single component coating material may include a single type of polymer or the reaction product of a single combination of polymer precursors. A single combination of polymer precursors may refer to a mixture of precursors that, when polymerized during curing, produce a single type of polymer coating material. The coating 120 may be applied to the glass article 102 by applying a coating solution comprising a single type of polymer or a single combination of polymer precursors and the organic solvent, when present.

In embodiments, the polymer coating material may comprise, consist of, or consist essentially of one or more polymers. In embodiments, the polymer coating material may comprise, consist of, or consist essentially of one or more polyimide, fluorinated polyimide, halogenated polyimide siloxanes, or combinations of these, and, optionally silica. In embodiments, the polymer coating material comprises, consists of, or consists essentially of a fluorinated polyimide. In embodiments, the coating solution applied to the glass article 102 to form the coating 120 may comprise, consist of, or consist essentially of a polymer, one or more polymer precursors, or both, optionally, an organic solvent, and optionally, silica. In embodiments, the coating solution applied to the glass article 102 to form the coating 120 may comprise, consist of, or consist essentially of a polyimide polymer, a fluorinated polyimide polymer, a halogenated polyimide siloxane polymer, one or more polyamic acid polymer precursors, silica, or combinations of these and, optionally, an organic solvent. In embodiments, the polymer coating material, the coating solution, or both do not contain any adhesion promoting materials, such as but not limited to titania. In embodiments, the polymer coating material, the coating solution, or both do not contain oxides of a metal or metalloid mixed into the polymer coating material or coating solution. In embodiments, the polymer coating material, the coating solution, or both do not contain transition metal oxides, such as but not limited to titania (titanium dioxide TiO₂). In embodiments, the polymer coating material, the coating solution, or both may contain less than 5 wt. %, less than 1 wt. %, or even less than 0.1 wt. % transition metal oxides, such as but not limited to titania, based on the total weight of coating materials (i.e., the total weight of polymers and solids dispersed and/or dissolved in the coating solution).

The coating 120 may be applied to the glass article 102 by contacting the glass article 102 with the coating solution comprising the coating polymers or polymer precursors. In particular, the coating 120 may be applied to the glass article 102 by contacting the coating solution with the adhesion promoting region 130 formed at the surface 104 of the glass article 102. As previously discussed, the coating solution contains one or more polymers, polymer precursors (e.g., polyamic acid), or combinations of these. The coating solution may further include a solvent, such as an organic solvent. In embodiments, the coating solution may comprise greater than or equal to 0.5 wt. %, greater than or equal to 1 wt. %, or even greater than or equal to 2 wt. % polymer or polymer precursor based on the total weight of the coating solution. In embodiments, the coating solution may comprise less than or equal to 10 wt. % or less than or equal to 5 wt. % polymer and/or polymer precursor based on the total weight of the coating solution. In embodiments, the coating solution may include from 0.5 wt. % to 10 wt. %, from 0.5 wt. % to 5 wt. %, from 1 wt. % to 10 wt. %, from 1 wt. % to 5 wt. %, from 2 wt. % to 10 wt. %, from 2 wt. % to 5 wt. %, about 1 wt. %, about 2 wt. %, or even about 3 wt. % polymers and/or polymer precursors based on the total weight of the coating solution. The weight percentage of solids (e.g., weight percent of polymers and polymer precursors) in the coating solution may be increased or decreased to increase or decrease, respectively, the thickness of the coating 120. For example, coating solutions having greater weight percentages of the polymers and/or polymer precursors may result in deposition of thicker layers of coating 120.

Referring again to FIGS. 1 and 2, the coating 120 may be applied to the surface 104 of the glass article 102 in a single deposition step where the coating 120 comprises a single layer. Deposition may be by a submersion process, or alternatively, the coating 120 may be applied by a spray or other suitable means, and optionally dried. Submersion processes for applying the coating 120 to the glass article 102 may include dip coating the glass article 102 in the coating solution. A description of suitable deposition methods for the coatings 120 described herein may be found in U.S. patent application Ser. No. 13/780,740 entitled “Glass Articles with Low-Friction Coatings,” the entire contents of which are incorporated by reference herein. In embodiments, multiple depositions of the polymer coating material may be performed. For example, multiple coating precursor depositions may be performed and then cured, or curing may follow each deposition step, such that a second coating of precursor is applied onto a cured layer. When multiple depositions of the polymer coating material are performed, the polymer coating materials of the subsequent coating depositions may be the same or different from the polymer coating materials of the first coating deposition step.

In embodiments, coating the surface 104 of the glass article 102 to produce the coated glass article 100 may comprise dip-coating the glass article 102 in the coating solution. The dip coating process may be conducted in a manner that places the adhesion promoting region 130 at the surface 104 of the glass article 102 into contact with the coating solution. In embodiments, coating the surface 104 of the glass article 102 may comprises dip coating the glass article 102 in a coating solution comprising from 1 wt. % to 5 wt. % polymer, polymer precursors, or both based on the total weight of the coating solution. Contacting the surface 104 of the glass article 102 with the coating solution may cause the polymer coating materials to be deposited onto the surface 104 of the glass article 102.

Following contact of the coating solution with the surface 104 of the glass article 102 and deposition of the polymer coating materials onto the surface 104 of the glass article 102, at least a portion of the organic solvent of the coating solution may liberated from the deposited polymer coating materials, either by passive drying or by active drying step(s) such as controlled air flow or increased temperatures. The coating 120 of the coated glass articles 100 may then be cured by exposure to heat. As described herein, “curing” refers to any process (usually by heating) which changes the material on the coating from the precursor material to an intermediate or final material. Curing may involve cross-linking of the polymers and/or polymerization of the various polymer precursors from the coating solution. The curing step may partially or fully polymerize a polymer precursor, such as imidize a polyamic acid. However, curing, as described herein, need not involve cross-linking of polymers, or the polymerization of polymers. For instance, the curing step may liberate any remaining solvents from the coating 120. Curing may comprise heating the coated glass article 102 at a curing temperature of 300° C. for about 30 minutes or less, or at a curing temperature greater than 300° C., such as at least 320° C., 340° C., 360° C., 380° C., or 400° C. Curing conditions may depend on the type of polymer precursor materials utilized. In embodiments, the coated glass article 100 may be cured at a curing temperature for a cure time, wherein the curing temperature and cure time are sufficient to remove diluents and/or organic solvents and cure the polymer coating material to produce the solid coating 120 on the surface 104 of the glass article 102. In embodiments, the coated glass article 100 may be cured at a curing temperature of from 300° C. to 400° C., or 360° C., for a cure time of from 1 minute to 30 minutes, or 15 minutes. In embodiments, no active curing is conducted to produce the coated glass article. In embodiments, curing is conducted to remove excess organic solvents.

Referring again to FIG. 2, applying the coating 120 to the adhesion promoting region 130 of the glass article 102 may form a surface layer 140 that comprises the adhesion promoting region 130 and the coating material infiltrated into the valleys 132 of the nanostructure of the adhesion promoting region 130. As shown in FIG. 2, the surface layer 140 may be defined between line A and line B of FIG. 2. As previously discussed, line A corresponds to a line parallel to the surface 104 of the glass article 102 and contacts a tip of the tallest peak 134 of the nanostructure of the adhesion promoting region and line B is a line parallel to the surface 104 and contacts the lowest point of the lowest valley 132 of the nanostructure of the adhesion promoting region. The surface layer 140 may be optically inert, such as having optical properties that are within 10%, within 5%, or even within 3% of the optical properties of the glass article 102 without the surface layer 140. The optical properties may include refractive index, Pegasus Number, or other optical property.

The coating 120 applied to the glass article 102 may have a thickness of less than or equal to 100 μm, less than or equal to 10 μm, less than or equal to 8 μm, less than or equal to 6 μm, less than or equal to 4 μm, less than or equal to 3 μm, less than or equal to 2 μm, or even less than or equal to 1 μm. Referring again to FIG. 2, the thickness of the coating 120 may be the distance from a centerline C of the adhesion promoting region to an outer surface 122 of the coating 120. In embodiments, the thickness of the coating 120 may be less than or equal to 800 nm, less than or equal to 600 nm, less than or equal to 400, less than or equal to nm 300 nm, less than or equal to 200 nm, or even less than or equal to 100 nm thick. In other embodiments, the coating 120 may be less than or equal to 90 nm thick, less than or equal to 80 nm thick, less than or equal to 70 nm thick, less than or equal to 60 nm thick, less than or equal to 50 nm, or even less than or equal to 25 nm thick. In embodiments, the coating 120 may have a thickness of greater than or equal to 10 nm, greater than or equal to 15 nm, greater than or equal to 20 nm, greater than or equal to 25 nm, greater than or equal to 30 nm, greater than or equal to 35 nm, greater than or equal to 40 nm, or even greater than or equal to 45 nm. In some embodiments, the coating 120 may have a thickness of from 10 nm to 100 μm, from 10 nm to 200 nm, from 20 nm to 50 nm, from 25 nm to 45 nm, or from 30 nm to 40 nm. Without being bound by any particular theory, it is believed that relatively thin coatings (i.e., less than 20 nm) may not adequately protect the glass, resulting in checking on the glass surface during vial-to-vial contact. In addition, such relatively thin coatings may not survive a depyrogenation process. On the other hand, relatively thick coatings (i.e., greater than 50 nm) may be more easily damaged and wear tracks in the coating may appear from vial-on-vial contacting. It should be noted that in the case of the relatively thick coatings, the wear tracks are believed to be deformations in the coating, and not in the glass. As described herein, wear tracks are visible tracks caused by abrasion on a coating, leaving a track or scuff. In some embodiments, wear tracks may signify glass checking and/or relatively high coefficient of friction (e.g., 0.7 or greater).

In embodiments, the coating 120 may not be of uniform thickness over the entirety of the glass article 102. For example, the coated glass article 100 may have a thicker coating 120 in some areas, due to the process of contacting the glass body 102 with one or more coating solutions that form the coating 120. In embodiments, the coating 120 may have a non-uniform thickness. For example, the coating thickness may be varied over different regions of a coated glass container 100, which may promote protection in a selected region. In embodiments, the outer surface 122 of the coating 120 may have a surface roughness that is less than the surface roughness of the adhesion promoting region, such as a surface roughness Ra of less than 0.3 as determined according to the methods disclosed herein.

In embodiments, a combination of polymers, such as polyimides or other polymer coating materials, may comprise at least 5 wt. %, at least 25 wt. %, at least 50 wt %, at least 60 wt. %, at least 70 wt. %, at least 80 wt. %, at least 90 wt. %, at least 95 wt. %, at least 96 wt. %, at least 97 wt. %, at least 98 wt. %, at least 99 wt. %, at least 99.5 wt. %, at least 99.8 wt. %, or even at least 99.9 wt. % of the coating 120. In embodiments, the coating 120 may comprise from 5 wt. % to 100 wt. % polymer coating materials following curing, based on the total weight of the coating 120. In embodiments, the total amount of the one or more polymer coating materials in the coating 120 may be from 5 wt. % to 99.8 wt. %, from 5 wt. % to 99.5 wt. %, from 5 wt. % to 99 wt. %, from 5 wt. % to 98 wt. %, from 5 wt. % to 97 wt. %, from 5 wt. % to 96 wt. %, from 5 wt. % to 95 wt. %, from 5 wt. % to 90 wt. %, from 5 wt. % to 80 wt. %, from 5 wt. % to 70 wt. %, from 5 wt. % to 60 wt. %, from 5 wt. % to 50 wt. %, from 5 wt. % to 25 wt. %, from 10 wt. % to 100 wt. %, from 10 wt. % to 99.8 wt. %, from 10 wt. % to 99.5 wt. %, from 10 wt. % to 99 wt. %, from 10 wt. % to 98 wt. %, from 10 wt. % to 97 wt. %, from 10 wt. % to 96 wt. %, from 10 wt. % to 95 wt. %, from 10 wt. % to 90 wt. %, from 10 wt. % to 80 wt. %, from 10 wt. % to 70 wt. %, from 10 wt. % to 60 wt. %, from 10 wt. % to 50 wt. %, from 10 wt. % to 25 wt. %, based on the total weight of the coating.

In embodiments, the coating 120 may include silica. The coating 120 may include greater than or equal to 1 wt. %, greater than or equal to 2 wt. %, greater than or equal to 3 wt. %, greater than or equal to 4 wt. %, greater than or equal to 5 wt. %, greater than or equal to 10 wt. %, or greater than or equal to 20 wt. % silica based on the total weight of the coating 120. In embodiments, the coating 120 may include from greater than 0 (zero) wt. % to 75 wt. %, from greater than 0 wt. % to 50 wt. %, from greater than 0 wt. % to 40 wt. %, from greater than 0 wt. % to 30 wt. %, greater than 0 wt. % to 20 wt. %, from 1 wt. % to 75 wt. %, from 1 wt. % to 50 wt. %, from 1 wt. % to 40 wt. %, from 1 wt. % to 30 wt. %, from 1 wt. % to 20 wt. %, from 2 wt. % to 75 wt. %, from 2 wt. % to 50 wt. %, from 2 wt. % to 40 wt. %, from 2 wt. % to 30 wt. %, from 2 wt. % to 20 wt. %, from 5 wt. % to 75 wt. %, from 5 wt. % to 50 wt. %, from 5 wt. % to 40 wt. %, from 5 wt. % to 30 wt. %, or from 5 wt. % to 20 wt. % silica based on the total weight of the coating 120. The coating 120 may include other constituents that do not substantially affect the optical properties of the coated glass article 100 compared to a glass article 102 without the coating 120.

In embodiments, where other non-polymer constituents are not present, the coating 120 may consist of or consist essentially of the polymer coating material. In embodiments, the coating 120 may consist of or consist essentially of at least one polyimide polymer and silica.

Various properties of the coated glass containers 100 (i.e., coefficient of friction, horizontal compression strength, 4-point bend strength) may be measured when the coated glass containers 100 are in an as-coated condition (i.e., following application of the coating 120 without any additional treatments other than curing if applicable) or following one or more processing treatments, such as those similar or identical to treatments performed on a pharmaceutical filling line, including, without limitation, washing, lyophilization, depyrogenation, autoclaving, or the like.

Depyrogenation is a process wherein pyrogens are removed from a substance. Depyrogenation of glass articles, such as pharmaceutical packages, can be performed by a thermal treatment applied to a sample in which the sample is heated to an elevated temperature for a period of time. For example, depyrogenation may include heating a glass container to a temperature of between about 250° C. and about 380° C. for a time period from about 30 seconds to about 72 hours, including, without limitation, 20 minutes, 30 minutes 40 minutes, 1 hour, 2 hours, 4 hours, 8 hours, 12 hours, 24 hours, 48 hours, and 72 hours. Following the thermal treatment, the glass container is cooled to room temperature. One conventional depyrogenation condition commonly employed in the pharmaceutical industry is thermal treatment at a temperature of about 250° C. for about 30 minutes. However, it is contemplated that the time of thermal treatment may be reduced if higher temperatures are utilized. The coated glass containers, as described herein, may be exposed to elevated temperatures for a period of time. The elevated temperatures and time periods of heating described herein may or may not be sufficient to depyrogenate a glass container. However, it should be understood that some of the temperatures and times of heating described herein are sufficient to depyrogenate a coated glass container, such as the coated glass containers 100 described herein. For example, as described herein, the coated glass containers 100 may be exposed to temperatures of from 250° C. to 400° C., such as about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes. It is recognized that depyrogenation processes may have times other than 30 minutes, and 30 minutes is used throughout this disclosure with a depyrogenation temperature for comparative purposes such as, for example, coefficient of friction testing following exposure to a defined depyrogenation condition.

As used herein, lyophilization conditions (i.e., freeze drying) refer to a process in which a sample is filled with a liquid that contains protein and then frozen at low temperatures, such as −100° C., followed by water sublimation for a time such as 20 hours at a temperatures such as −15° C. under vacuum.

As used herein, autoclave conditions refer to steam purging a sample for a time period such as 10 minutes at 100° C., followed by a 20 minute dwelling period wherein the sample is exposed to a 121° C. environment, followed by 30 minutes of heat treatment at 121° C.

The coating 120 applied to the adhesion promoting region 130 of the surface 104 of the glass article 102 may be optically inert. As used herein, the term “optically inert” refers to a feature, such as the adhesion promoting region 130, coating 120, or other feature, producing a minimal change in the optical properties of the glass, such as a change of less than 10%, less than 5%, or even less than 3% of an optical property of the glass. The optical properties of the glass may include but are not limited to a refractive index of the glass. In embodiments, the coated glass article 100 having the coating 120 applied to the surface 104 of the glass article 102 may have a refractive index that is within 10%, within 5%, or even within 3% of a refractive index of the glass article 102 without the coating 120. As described herein, a refractive index of the coated glass article 100 can be measured before a thermal treatment or after a thermal treatment, such as the heat treatments described herein. In embodiments, following a heat treatment of the coated glass article 100 at a temperature of from 250° C. to 400° C. for a time period of 30 minutes, such as a temperature of about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes, or after exposure to lyophilization conditions, or after exposure to autoclave conditions, the coated glass article 100 may have a refractive index that is within 10%, within 5%, or even within 3% of a refractive index of the glass article 102 without the coating 120.

The optical properties of the coating 120 may be evaluated by imaging the coated glass article 100 using a Pegasus® imaging system, as previously discussed, and determining a Pegasus Number from the image data. The Pegasus Number is indicative of the optical response of the coated glass article 100. The glass article 102 without the adhesion promoting region 130 or the coating 120 may have a Pegasus Number of 32. The coated glass article 100 having the adhesion promoting region 130 on the surface 104 of the glass article 102 and the coating 120 applied thereto may have a Pegasus Number of within 10%, within 5%, or even within 3% of the Pegasus Number of the glass article 102 without the adhesion promoting region 130 or the coating 120. As described herein, Pegasus Number of the coated glass article 100 can be measured before a thermal treatment or after a thermal treatment, such as the heat treatments described herein. In embodiments, following a heat treatment of the coated glass article 100 at a temperature of from 250° C. to 400° C. for a time period of 30 minutes, such as a temperature of about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes, or after exposure to lyophilization conditions, or after exposure to autoclave conditions, the coated glass article 100 may have a Pegasus Number that is within 10%, within 5%, or even within 3% of a Pegasus Number of the glass article 102 without the coating 120.

In embodiments, the adhesion promoting region 130 and the coating 120 do not impede optical inspection of the coated glass article 100 or the contents of the coated glass article 100, such as optical inspection to verify volume or chemical composition of contents filled into the coated glass articles 100, to inspect the integrity of the coated glass article 100, or to inspect other features of the coated glass article 100 or the contents thereof.

The transparency and color of the coated container may be assessed by measuring the light transmission of the container within a range of wavelengths between 400-700 nm using a spectrophotometer. The measurements are performed such that a light beam is directed normal to the container wall such that the beam passes through the coating twice, first when entering the container and then when exiting it. In some embodiments in which the coated glass article 100 is a coated glass container, the light transmission through the coated glass container may be greater than or equal to 55% of a light transmission through an uncoated glass container (passing through two walls of the container) for wavelengths from 400 nm to 700 nm. As described herein, a light transmission can be measured before a thermal treatment or after a thermal treatment, such as the heat treatments described herein. For example, for each wavelength of from 400 nm to 700 nm, the light transmission of a coated glass container may be greater than or equal to 55% of a light transmission through an uncoated glass container. In embodiments, the light transmission through the coated glass container may be greater than or equal to 55%, greater than or equal to 60%, greater than or equal to 65%, greater than or equal to 70%, greater than or equal to 75%, greater than or equal to 80%, greater than or equal to 90%, or even greater than or equal to 95% of a light transmission through an uncoated glass container for wavelengths from about 400 nm to about 700 nm.

As described herein, a light transmission can be measured before an environmental treatment, such as a thermal treatment described herein, or after an environmental treatment. For example, following a heat treatment of the coated glass container at a temperature of from 250° C. to 400° C. for a time period of 30 minutes, such as a temperature of about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes, or after exposure to lyophilization conditions, or after exposure to autoclave conditions, the light transmission through the coated glass container may be greater than or equal to 55%, greater than or equal to 60%, greater than or equal to 65%, greater than or equal to 70%, greater than or equal to 75%, greater than or equal to 80%, greater than or equal to 90%, or even greater than or equal to 95% of a light transmission through an uncoated glass container for wavelengths from 400 nm to 700 nm. In embodiments, the coated glass article 100 may be perceived as colorless and transparent to the naked human eye when viewed at any angle. In some other embodiments, the coating 120 may have a perceptible tint, such as when the coating 120 comprises a polymer which is colored.

In embodiments, the coating 120 may be a friction reducing coating. The coefficient of friction (μ) of the portion of the coated glass article 100 with the coating 120 may have a lower coefficient of friction than a surface of an uncoated glass article formed from a same glass composition. A coefficient of friction (μ) is a quantitative measurement of the friction between two surfaces and is a function of the mechanical and chemical properties of the first and second surfaces, including surface roughness, as well as environmental conditions such as, but not limited to, temperature and humidity. As used herein, a coefficient of friction measurement for the coated glass article 100 is reported as the coefficient of friction between the outer surface of a first glass article (such as a glass vial having an outer diameter of between about 16.00 mm and about 17.00 mm) and the outer surface of second glass article which is substantially identical to the first glass article, wherein the first and second glass articles have the same body and the same composition of the coating 120 (when applied) and have been exposed to the same environments prior to fabrication, during fabrication, and after fabrication. Unless otherwise denoted herein, the coefficient of friction refers to the maximum coefficient of friction measured with a normal load of 30 N measured on an article-on-article testing jig, such as a vial-on-vial testing jig as described herein. However, it should be understood that a coated glass article 100 which exhibits a maximum coefficient of friction at a specific applied load will also exhibit the same or better (i.e., lower) maximum coefficient of friction at a lesser load. For example, if a coated glass article 100 exhibits a maximum coefficient of friction of 0.5 or lower under an applied load of 50 N, the coated glass article 100 will also exhibit a maximum coefficient of friction of 0.5 or lower under an applied load of 25 N. To measure a maximum coefficient of friction, local maxima at or near the beginning of the test are excluded, as such maxima at or near the beginning of the test represent static coefficient of friction. As described in the embodiments herein, the coefficient of friction was measured where the speed of the glass articles relative to one another was about 0.67 mm/s.

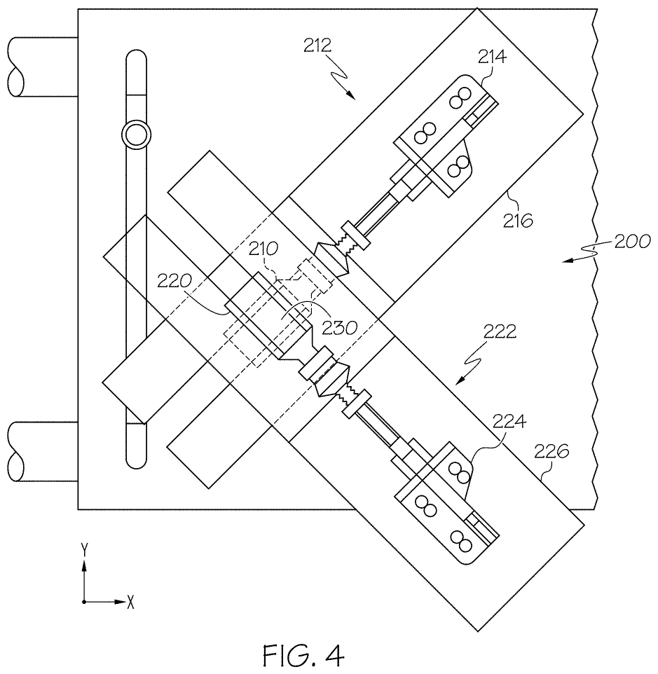

In embodiments described herein, the coefficients of friction of the glass articles that are glass containers (both coated and uncoated) are measured with a vial-on-vial testing jig. The testing jig 200 is schematically depicted in FIG. 4. The same apparatus may also be used to measure the frictive force between two glass articles positioned in the jig. The vial-on-vial testing jig 200 comprises a first clamp 212 and a second clamp 222 arranged in a cross configuration (i.e., perpendicular to one another). The first clamp 212 comprises a first securing arm 214 attached to a first base 216. The first securing arm 214 attaches to the first glass container 210 and holds the first glass container 210 stationary relative to the first clamp 212. Similarly, the second clamp 222 comprises a second securing arm 224 attached to a second base 226. The second securing arm 224 attaches to the second glass container 220 and holds it stationary relative to the second clamp 222. The first glass container 210 is positioned on the first clamp 212 and the second glass container 220 is positioned of the second clamp 222 such that the long axis of the first glass container 210 and the long axis of the second glass container 220 are positioned at about a 90° angle relative to one another and on a horizontal plane defined by the x-y axis.

A first glass container 210 is positioned in contact with the second glass container 220 at a contact point 230. A normal force is applied in a direction orthogonal to the horizontal plane defined by the x-y axis. The normal force may be applied by a static weight or other force applied to the second clamp 222 upon a stationary first clamp 212. For example, a weight may be positioned on the second base 226 and the first base 216 may be placed on a stable surface, thus inducing a measurable force between the first glass container 210 and the second glass container 220 at the contact point 230. Alternatively, the force may be applied with a mechanical apparatus, such as a UMT (universal mechanical tester) machine.

The first clamp 212 or second clamp 222 may be moved relative to the other in a direction which is at a 45° angle with the long axis of the first glass container 210 and the second glass container 220. For example, the first clamp 212 may be held stationary and the second clamp 222 may be moved such that the second glass container 220 moves across the first glass container 210 in the direction of the x-axis. A similar setup is described by R. L. De Rosa et al., in “Scratch Resistant Polyimide Coatings for Alumino Silicate Glass Surfaces” in The Journal of Adhesion, 78: 113-127, 2002. To measure the coefficient of friction, the force required to move the second clamp 222 and the normal force applied to first and second glass containers 210, 220 are measured with load cells and the coefficient of friction is calculated as the quotient of the frictive force and the normal force. The jig is operated in an environment of 25° C. and 50% relative humidity. Although described in the context of glass containers, it is understood that the vial-on-vial testing jig 200 depicted in FIG. 4 may be capable of testing the coefficient of friction and frictive forces for other types of glass articles.

In the embodiments described herein, the portion of the coated glass article 100 with the coating 120 may have a coefficient of friction of less than or equal to 0.7 relative to a like-coated glass article, as determined with the vial-on-vial jig 200 described herein in conjunction with FIG. 4. In embodiments, the portion of the coated glass article 100 having the coating 120 may have a coefficient of friction less than or equal to 0.6, or even less than or equal to 0.5. In embodiments, the portion of the coated glass article 100 having the coating 120 may have a coefficient of friction of less than or equal to 0.4 or even less than or equal to 0.3. The portion of the coated glass article 100 having the coating 120 may have a coefficient of friction of from greater than 0 (zero) to 0.7, such as from greater than 0 to 0.6, from greater than 0 to 0.5, from greater than 0 to 0.4, or from greater than 0 to 0.3. Coated glass articles with coefficients of friction less than or equal to 0.7 may exhibit improved resistance to frictive damage and, as a result, may have improved mechanical properties. For comparison, conventional uncoated glass articles (without a coating) may have a coefficient of friction of greater than 0.7.

In some embodiments described herein, the coefficient of friction of the portion of the coated glass article 100 with the coating 120 is at least 20% less than a coefficient of friction of a surface of an uncoated glass article formed from a same glass composition (the coated glass article 100 has the coating and the uncoated glass article is the same glass article except for not having the coating). For example, the coefficient of friction of the portion of the coated glass article 100 with the coating 120 may be at least 20% less, at least 25% less, at least 30% less, at least 40% less, even at least 50% less, or even at least 80% less than a coefficient of friction of a surface of an uncoated glass article formed from a same glass composition.

In embodiments, the portion of the coated glass article 100 with the coating 120 may have a coefficient of friction of less than or equal to 0.7 after exposure to a temperature of from 250° C. to 400° C. for a period of time of 30 minutes, such as a temperature of about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes. In embodiments, the portion of the coated glass article 100 with the coating 120 may have a coefficient of friction of less than or equal to 0.6, less than or equal to 0.5, less than or equal to 0.4, less than or equal to 0.3, or even less than or equal to 0.2 after exposure to a temperature of from 250° C. to 400° C. for a time of 30 minutes, such as exposure to a temperature of about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes. The portion of the coated glass article 100 having the coating 120 may have a coefficient of friction of from greater than 0 (zero) to 0.7, such as from greater than 0 to 0.6, from greater than 0 to 0.5, from greater than 0 to 0.4, or from greater than 0 to 0.3 after exposure to a temperature of from 250° C. to 400° C. for a time of 30 minutes. In some embodiments, the coefficient of friction of the portion of the coated glass article 100 with the coating 120 may not increase by more than about 30% after exposure to a temperature of about 250° C. (or about 260° C.) for 30 minutes. In other embodiments, coefficient of friction of the portion of the coated glass article 100 with the coating 120 may not increase by more than 30%, more than 25%, more than 20%, more than 15%, or even more than 10% after exposure to a temperature of from 250° C. to 400° C. for a time of 30 minutes, such exposure to a temperature of about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes. In other embodiments, coefficient of friction of the portion of the coated glass article 100 with the coating 120 may not increase by more than 0.5, by more than 0.45, by more than 0.4, by more than 0.35, by more than 0.3, by more than 0.25, by more than 0.2, by more than 0.15, by more than 0.1, or by more than 0.05 after exposure to a temperature of from 250° C. to 400° C. for a time of 30 minutes, such as exposure to a temperature of about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes. In embodiments, the coefficient of friction of the portion of the coated glass article 100 with the coating 120 may not increase at all after exposure to a temperature of 250° C. to 400° C. for a time of 30 minutes.

In embodiments, the portion of the coated glass article 100 with the coating 120 may have a coefficient of friction of less than or equal to 0.7 after being submerged in a water bath at a temperature of about 70° C. for 10 minutes. In other embodiments, the portion of the coated glass article 100 with the coating 120 may have a coefficient of friction of less than or equal to 0.7, less than or equal to 0.6, less than or equal to 0.5, less than or equal to 0.4, or even less than or equal to 0.3 after being submerged in a water bath at a temperature of about 70° C. for 5 minutes, 10 minutes, 20 minutes, 30 minutes, 40 minutes, 50 minutes, or even 1 hour. The portion of the coated glass article 100 having the coating 120 may have a coefficient of friction of from greater than 0 (zero) to 0.7, such as from greater than 0 to 0.6, from greater than 0 to 0.5, from greater than 0 to 0.4, or from greater than 0 to 0.3 after being submerged in a water bath at a temperature of about 70° C. for 5 minutes, 10 minutes, 20 minutes, 30 minutes, 40 minutes, 50 minutes, or even 1 hour. In embodiments, the coefficient of friction of the portion of the coated glass article 100 with the coating 120 may not increase by more than about 30% after being submerged in a water bath at a temperature of about 70° C. for 10 minutes. In embodiments, coefficient of friction of the portion of the coated glass article 100 with the coating 120 may not increase by more than 25%, by more than 20%, by more than 15%, or even by more than 10% after being submerged in a water bath at a temperature of about 70° C. for 5 minutes, 10 minutes, 20 minutes, 30 minutes, 40 minutes, 50 minutes, or even 1 hour. In embodiments, the coefficient of friction of the portion of the coated glass article 100 with the coating 120 may not increase at all after being submerged in a water bath at a temperature of about 70° C. for 5 minutes, 10 minutes, 20 minutes, 30 minutes, 40 minutes, 50 minutes, or even 1 hour.

In embodiments, the portion of the coated glass article 100 with the coating 120 may have a coefficient of friction of less than or equal to 0.7 after exposure to lyophilization conditions. In embodiments, the portion of the coated glass article 100 with the coating 120 may have a coefficient of friction of less than or equal to 0.6, less than or equal to 0.5, less than or equal to 0.4, or even less than or equal to 0.3 after exposure to lyophilization conditions. The portion of the coated glass article 100 having the coating 120 may have a coefficient of friction of from greater than 0 (zero) to 0.7, such as from greater than 0 to 0.6, from greater than 0 to 0.5, from greater than 0 to 0.4, or from greater than 0 to 0.3 after exposure to lyophilization conditions. In embodiments, the coefficient of friction of the portion of the coated glass article 100 with the coating 120 may not increase by more than 30% after exposure to lyophilization conditions. In other embodiments, coefficient of friction of the portion of the coated glass article 100 with the coating 120 may not increase by more than 25%, by more than 20%, by more than 15%, or even by more than 10% after exposure to lyophilization conditions. In some embodiments, the coefficient of friction of the portion of the coated glass article 100 with the coating 120 may not increase at all after exposure to lyophilization conditions.

In embodiments, the portion of the coated glass article 100 with the coating 120 may have a coefficient of friction of less than or equal to 0.7 after exposure to autoclave conditions. In embodiments, the portion of the coated glass article 100 with the coating 120 may have a coefficient of friction of less than or equal to 0.6, less than or equal to 0.5, less than or equal to 0.4, or even less than or equal to 0.3 after exposure to autoclave conditions. The portion of the coated glass article 100 having the coating 120 may have a coefficient of friction of from greater than 0 (zero) to 0.7, such as from greater than 0 to 0.6, from greater than 0 to 0.5, from greater than 0 to 0.4, or from greater than 0 to 0.3 after exposure to autoclave conditions. In embodiments, the coefficient of friction of the portion of the coated glass article 100 with the coating 120 may not increase by more than 30% after exposure to autoclave conditions. In other embodiments, coefficient of friction of the portion of the coated glass article 100 with the coating 120 may not increase by more than 25%, more than 20%, more than 15%, or even more than 10% after exposure to autoclave conditions. In some embodiments, the coefficient of friction of the portion of the coated glass article 100 with the coating 120 may not increase at all after exposure to autoclave conditions.

The coated glass articles 100 described herein may have a horizontal compression strength. The horizontal compression strength of the coated glass articles 100, as described herein, can be measured by positioning the coated glass article 100 horizontally between two parallel platens which are oriented parallel to a long axis of the coated glass article 100 (e.g., the center axis of a cylindrical glass vial). A mechanical load is then applied to the coated glass article 100 with the platens in the direction perpendicular to the long axis of the glass article. Prior to being placed in the platens, the coated glass articles 100 are wrapped in 2 inch tape, and the overhang is cut off or folded around the bottom of the coated glass article 100. The glass article is then positioned within an index card that is stapled around the specimen. The load rate for compression of the glass articles is 0.5 in/min, meaning that the platens move towards each other at a rate of 0.5 in/min. The horizontal compression strength is measured at 25° C.±2° C. and 50%±5% relative humidity. In embodiments, the horizontal compression test may be performed within 1 hour (and not more than 24 hours) following depyrogenation of the coated glass article 100 to simulate pharmaceutical filling line conditions. The horizontal compression strength is a measurement of load at failure, and measurement of the horizontal compression strength can be given as a failure probability at a selected normal compression load. As used herein, the horizontal compression strength at failure occurs when the glass article ruptures under the horizontal compression in least 50% of samples tested. Thus, the horizontal compression strength is provided for a group of samples. In embodiments, the coated glass article 100 may have a horizontal compression strength of at least 10%, at least 20%, or at least 30% greater than an uncoated glass article that does not have the coating 120.

Referring now to FIGS. 1 and 4, the horizontal compression strength measurement may also be performed on a coated glass article 100 that has been abraded. Specifically, operation of the testing jig 200 may create damage on the outer surface 122 of the coating 120 on the coated glass article 100, such as a surface scratch or abrasion that weakens the strength of the coated glass article 100. The coated glass article 100 can then subjected to the horizontal compression strength testing procedure described above, wherein the glass article is placed between two platens with the scratch pointing outward parallel to the platens. The scratch can be characterized by the selected normal pressure applied by a vial-on-vial jig and the scratch length. Unless identified otherwise, scratches for abraded glass articles for the horizontal compression procedure are characterized by a scratch length of 20 mm created by a normal load of 30 N. In embodiments, the scratch may be positioned at a 90° angle relative to the platens, ±5°.

The coated glass articles 100 can be evaluated for horizontal compression strength following a heat treatment. The heat treatment may be exposure to a temperature of from 250° C. to 400° C. for a period of time of 30 minutes, such as a temperature of about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes. In embodiments, the horizontal compression strength of the coated glass article 100 is not reduced by more than 20%, more than 30%, or even more than 40% after being exposed to a heat treatment, such as those described above, and then being abraded, as described above. In one embodiment, the horizontal compression strength of the coated glass article 100 is not reduced by more than 20% after being exposed to a heat treatment of from 250° C. to 400° C. for a time period of 30 minutes, such as a temperature of about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes, and then being abraded.

The coated glass articles 100 described herein may be thermally stable after heating to a temperature of at least 250° C. (or 260° C., or 280° C., or 300° C.) for a time period of 30 minutes. The phrase “thermally stable,” as used herein, means that the coating 120 applied to the glass article 102 remains substantially intact on the surface of the coated glass article 100 after exposure to the elevated temperatures such that, after exposure, the mechanical properties of the coated glass article 100, specifically the coefficient of friction and the horizontal compression strength, are only minimally affected, if at all. This indicates that the coating 120 remains adhered to the surface of the glass article 102 following elevated temperature exposure and continues to protect the glass article from mechanical insults such as abrasions, impacts and the like.

In embodiments described herein, a coated glass article 100 is considered to be thermally stable if the coated glass article 100 meets both a coefficient of friction standard and a horizontal compression strength standard after heating to the specified temperature and remaining at that temperature for the specified time. To determine if the coefficient of friction standard is met, the coefficient of friction of a first coated glass article is determined in as-received condition (i.e., prior to any thermal exposure) using the testing jig depicted in FIG. 4 and a 30 N applied load. A second coated glass article (i.e., a glass article having the same glass composition and the same coating composition as the first coated glass article) is thermally exposed under the prescribed conditions and cooled to room temperature. Thereafter, the coefficient of friction of the second glass article is determined using the testing jig depicted in FIG. 4 to abrade the coated glass article with a 30 N applied load resulting in an abrasion (i.e., a “scratch”) having a length of approximately 20 mm. If the coefficient of friction of the second coated glass article is less than 0.7 and the surface of the glass of the second glass article in the abraded area does not have any observable damage, then the coefficient of friction standard is met for purposes of determining the thermal stability of the coating. The term “observable damage,” as used herein means that the surface of the glass in the abraded area of the glass article contains less than six glass checks per 0.5 cm of length of the abraded area when observed with a Nomarski or differential interference contrast (DIC) spectroscopy microscope at a magnification of 100× with LED or halogen light sources. A standard definition of a glass check or glass checking is described in G. D. Quinn, “NIST Recommended Practice Guide: Fractography of Ceramics and Glasses,” NIST special publication 960-17 (2006).

To determine if the horizontal compression strength standard is met, a first coated glass article is abraded in the testing jig depicted in FIG. 4 under a 30 N load to form a 20 mm scratch. The first coated glass article is then subjected to a horizontal compression test, as described herein, and the retained strength of the first coated glass article is determined. A second coated glass article (i.e., a glass article having the same glass composition and the same coating composition as the first coated glass article) is thermally exposed under the prescribed conditions and cooled to room temperature. Thereafter, the second coated glass article is abraded in the testing jig depicted in FIG. 4 under a 30 N load. The second coated glass article is then subjected to a horizontal compression test, as described herein, and the retained strength of the second coated glass article is determined. If the retained strength of the second coated glass article does not decrease by more than 20% relative to the first coated glass article (i.e., the load to failure does not decrease by more than 20%) then the horizontal compression strength standard is met for purposes of determining the thermal stability of the coating.

The coated glass articles 100 are considered to be thermally stable if the coefficient of friction standard and the horizontal compression strength standard are met after exposing the coated glass articles 100 to a temperature of at least 250° C. (or 260° C. or 280° C.) for a time period of at least 30 minutes (i.e., the coated glass articles 100 are thermally stable at a temperature of at least 250° C. (or 260° C. or 280° C.) for a time period of 30 minutes). The thermal stability may also be assessed at temperatures from 250° C. (or 260° C. or 280° C.) up to 400° C. For example, in embodiments, the coated glass articles 100 will be considered to be thermally stable if the standards are met after exposure to a temperature of at least 270° C. or even at least 280° C. for a time period of 30 minutes. In still other embodiments, the coated glass articles 100 will be considered to be thermally stable if the standards are met after exposure to a temperature of at least 290° C. or even at least 300° C. for a time period of 30 minutes. In further embodiments, the coated glass articles 100 will be considered to be thermally stable if the standards are met after exposure to a temperature of at least 310° C. or even at least 320° C. for a time period of 30 minutes. In still other embodiments, the coated glass articles 100 will be considered to be thermally stable if the standards are met after exposure to a temperature of at least 330° C. or even at least 340° C. for a time period of 30 minutes. In yet other embodiments, the coated glass articles will be considered to be thermally stable if the standards are met after exposure to a temperature of at least 350° C. or even at least 360° C. for a time period of 30 minutes. In some other embodiments, the coated glass articles 100 will be considered to be thermally stable if the standards are met after exposure to a temperature of at least 370° C. or even at least 380° C. for a time period of 30 minutes. In still other embodiments, the coated glass containers will be considered to be thermally stable if the standards are met after exposure to a temperature of at least 390° C. or even at least 400° C. for a time period of 30 minutes.

The coated glass articles 100 disclosed herein may also be thermally stable over a range of temperatures, meaning that the coated glass articles 100 are thermally stable by meeting the coefficient of friction standard and horizontal compression strength standard at each temperature in the range. For example, in the embodiments described herein, the coated glass articles 100 may be thermally stable from at least 250° C. (or 260° C. or 280° C.) to a temperature of less than or equal to 400° C. In embodiments, the coated glass articles 100 may be thermally stable in a range from at least 250° C. (or 260° C. or 280° C.) to 350° C. In some embodiments, the coated glass articles 100 may be thermally stable at a temperature range of from 280° C. to 350° C., from 290° C. to 340° C., from 300° C. to 380° C., or from 320° C. to 360° C.

The coated glass articles 100 described herein have a four point bend strength. To measure the four point bend strength of a glass article that is cylindrical, such as a glass container, a glass tube that is the precursor to the coated glass container 100 is utilized for the measurement. The glass tube has a diameter that is the same as the glass container but does not include a glass container base or a glass container mouth (i.e., prior to forming the tube into a glass container). The glass tube is then subjected to a four point bend stress test to induce mechanical failure. The test is performed at 50% relative humidity with outer contact members spaced apart by 9″ and inner contact members spaced apart by 3″ at a loading rate of 10 mm/min.

The four point bend stress measurement may also be performed on a coated and abraded tube. The glass tube may be coated according to the methods disclosed herein, such as by exposing the surface of the glass tube to the aqueous treating medium to increase the surface area and then applying the coating comprising one or more of the coating materials disclosed herein. Operation of the testing jig 200 may create an abrasion on the glass tube surface such as a surface scratch that weakens the strength of the glass tube, as described in the measurement of the horizontal compression strength of an abraded coated glass article. The glass tube is then subjected to a four point bend stress test to induce mechanical failure. The test is performed at 25° C. and at 50% relative humidity using outer probes spaced apart by 9″ and inner contact members spaced apart by 3″ at a loading rate of 10 mm/min, while the tube is positioned such that the scratch is put under tension during the test.

In some embodiments, the four point bend strength of a glass tube with a coating after abrasion shows on average at least 10%, at least 20%, or even at least 50% greater mechanical strength compared to the mechanical strength of an uncoated glass tube abraded under the same conditions.

In some embodiments, after the coated glass article 100 is abraded by an identical glass article with a 30 N normal force, the coefficient of friction of the abraded area of the coated glass article 100 does not increase by more than about 20% following another abrasion by an identical glass article with a 30 N normal force at the same spot, or does not increase at all. In other embodiments, after the coated glass article 100 is abraded by an identical glass article with a 30 N normal force, the coefficient of friction of the abraded area of the coated glass article 100 does not increase by more than 15% or even more than 10% following another abrasion by an identical glass article with a 30 N normal force at the same spot, or does not increase at all. However, it is not necessary that all embodiments of the coated glass article 100 display such properties.

In some embodiments, the coated glass article 100 may have a coating 120 that is capable of receiving an adhesive label. That is, the coated glass article 100 may receive an adhesive label on the coated surface (i.e., outer surface 122 of the coating 120) such that the adhesive label is securely attached. However, the ability of attachment of an adhesive label is not a requirement for all embodiments of the coated glass articles 100 described herein.

### EXAMPLES

The various embodiments of coated glass articles disclosed herein will be further clarified by the following examples. The examples are illustrative in nature, and should not be understood to limit the subject matter of the present disclosure.

### Example 1

In Example 1, coated glass containers are prepared by etching the outer surface of glass containers to produce an adhesion promoting region and then applying a coating to the etched glass containers to produce the coated glass articles. The morphology of the surface of the glass containers before and after etching is evaluated to demonstrate formation of the adhesion promoting region through exposure to the floss etching solution. The glass containers for Example 1 were ion-exchanged VALOR® glass vials from Corning. The glass vials were subsequently ion-exchange strengthened, as is described in U.S. patent application Ser. No. 13/660,394, prior to formation of the adhesion promoting region and application of the coating. The glass vials had an outer diameter of about 16.00 mm. The vials to be coated were washed with de-ionized water, blown dry with nitrogen, and finally cleaned by exposure to oxygen plasma for 15 seconds prior to coating.

The nanostructure of the adhesion promoting region was formed on the glass vials by leaching the glass vials in 0.15 M hydrochloric acid (HCl) at 95° C. for 6 hours. Exposure to HCl preferentially removed low durability components (Al, K, etc.) present in the glass. The glass vials were then contacted with an aqueous treating medium for forming the adhesion promoting layer on the outer surface of the glass vials. The aqueous treating medium was a low fluoride content aqueous solution comprising 0.26 M ammonium bifluoride and 1 M citric acid. The glass vials were contacted with the aqueous treating medium for a time period of 30 minutes. The treated glass vials comprising the adhesion promoting region were then stored in deionized water. Prior to application of the coating, the treated glass vials were dried sequentially, first at 65° C. for 24 hours, and then at 120° C. overnight and stored at 120° C. Coated glass vials were prepared by dip coating the glass vials in a coating solution comprising a polyimide polymer coating material at standard temperature and pressure to produce the coated glass vial having a polymer infiltrated surface layer comprising the adhesion promoting region and the polymer coating applied on top of the adhesion promoting region. The withdrawing speed of the dip coating was fixed at 60 cm/min to attain a dry coating thickness of from about 100 nm to 150 nm. Thereafter, the coated glass vials were cured by placing them into a preheated furnace at 360° C. for 15 minutes.

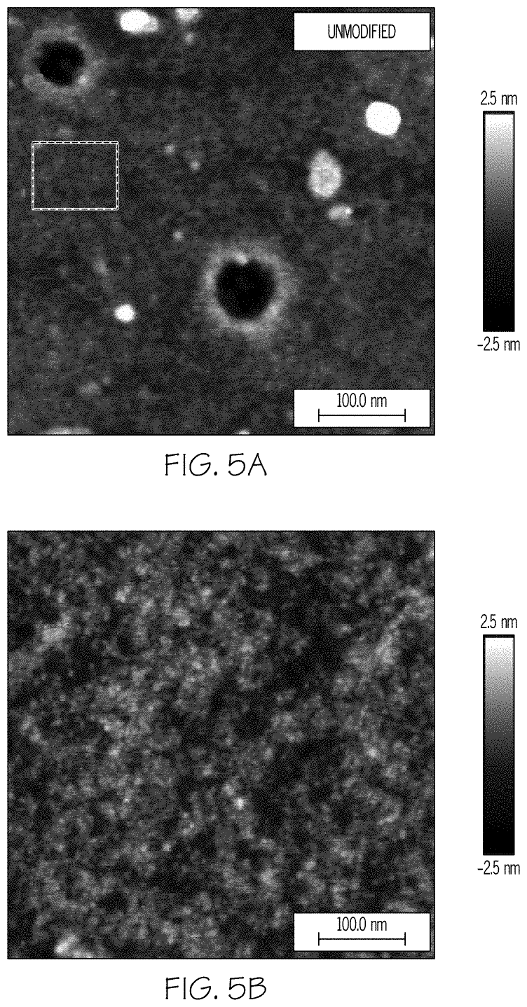

The surface morphology of the starting glass vials and the treated glass vials were then characterized by atomic force microscopy (AFM) imaging. Referring now to FIGS. 5A and 5B, AFM images of the morphology of the surface of the starting glass vial before (5A) and after (5B) treatment with the aqueous treating medium are shown. In FIGS. 5A and 5B, darker portions show deeper topographical features and lighter portions show higher topological features. In other words, features that are darker in color in FIGS. 5A and 5B are farther away from the microscope lens and, thus, are deeper. As shown in FIG. 5A, the un-treated starting glass vial has a surface that is generally smooth, as indicated by the generally minor variations in grayscale contrast on the surface (e.g., in the square area and not including the surface inclusions indicated by the large circular dark-colored features. The surface inclusions are present in the as-received glass vials and are not created by treatment with the aqueous treating medium. The surface inclusions are included in the frame of the image in FIG. 5A for purposes of focusing the optics of the imaging device). Referring now to FIG. 5B, the morphology of the treated glass vials after contacting with the aqueous treating medium for 30 minutes, show an increase in the roughness of the surface morphology of the treated glass vials compared to the starting un-treated glass vials. This difference is shown by the greater color contrast of the surface in FIG. 5B compared to FIG. 5A.

### Example 2

In Example 2, the surface roughness of the surface of the glass containers is evaluated at various times during the process of forming the adhesion promoting region. The glass containers and process of forming the adhesion promoting region through contact with the aqueous treating medium are same as described in Example 1. In Example 2, the glass vials were exposed to the aqueous treating medium for durations of 15 minutes, 30 minutes, and 45 minutes. The surface roughness of the surface of the glass containers before leaching, after leaching, and after 15, 30 and 45 minutes of contact with the aqueous treating medium were evaluated. The results are provided in Table 1. The results in Table 1 show increases in surface roughness from leaching and then exposure to the aqueous treating medium.

TABLE 1

| | Surface |
|---|---|
| | Roughness |
| Glass Container | (Ra) |
| Starting Untreated Glass Vial | 0.23 |
| Leached Glass Vial | 0.31 |
| Glass Vial Etched for 15 min. | 0.40 |
| Glass Vial Etched for 30 min | 0.42 |
| Glass Vial Etched for 45 min | 0.60 |

### Example 3

In Example 3, glass containers are treated with the aqueous treating medium to form the adhesion promoting region and then coated with various coatings to evaluate the effectiveness of the adhesion promoting layer in improving adhesion of the coatings to the surface of the glass container compared to glass containers without the adhesion promoting layer. The performances of coating formulations on ion-exchanged glass vials having the adhesion promoting region formed thereon were evaluated with solutions of the polymer structures shown in Table 2. The glass vials were ion-exchanged VALOR® glass vials from Corning. The glass vials were leached as described previously in Example 1 and then contacted with the aqueous treating medium for 30 minutes to produce the adhesion promoting region at the surface of the glass vials. A second set of glass vials were contacted with the aqueous treating medium for 45 minutes. The coated glass vials from both sets were prepared by dip-coating the glass vials having the adhesion promoting region formed thereon in a polymer coating solution having a concentration of polymer coating material in a range of from 1 wt. % to 5 wt. %. The withdrawing speed of the dip-coating process was fixed at 60 cm/min to attain a dry coating thickness of from about 30 nm to 40 nm. The dip-coated glass vials were then nominally cured at a temperature of 360° C. for 15 minutes.

TABLE 2

| Sample | | |
|---|---|---|
| | Comp. | |
| Ex. 3 | Ex. 4 | Polymer Coating |
| 3A | 4A | 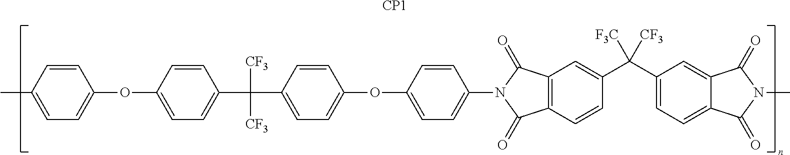 |
| 3B | 4B | 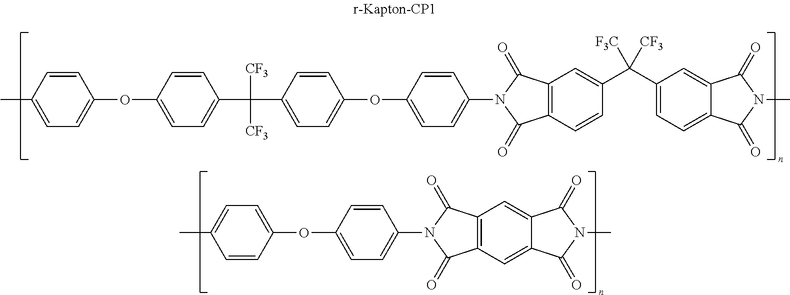 |
| 3C | 4C | 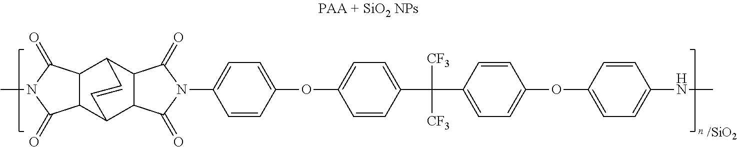 |
| — | 4D | None |

### Comparative Example 4

In Comparative Example 4, ion-exchanged glass vials were coated with the coatings in Table 2 of Example 3 but without forming the adhesion promoting region at the surface of the glass vials prior to applying the coating. The glass vials were the same ion-exchanged VALOR® glass vials from Corning used in Example 3. The glass vials were not leached and not contacted with the aqueous treating medium to form the adhesion promoting region, but rather, the as-received glass vials were directly coated with the coatings in Table 2. For Comparative Example 4, the coatings were applied to each of the glass vials according to the dip-coating and curing processes described in Example 3.

### Example 5: Coating Performance

The samples of Example 3 and Comparative Example 4 were evaluated for coefficient of friction (COF). Each of the samples produced according to Example 3 and Comparative Example 4 were tested for COF by a process consistent with the methods described in the present disclosure utilizing the testing jig of FIG. 4. For each sample, the COF was evaluated under three test conditions: ten scratch passes at a load of 10 Newtons (N) (10×10 N), a single pass at a load of 10 N, and a single pass at a load of 30 N.

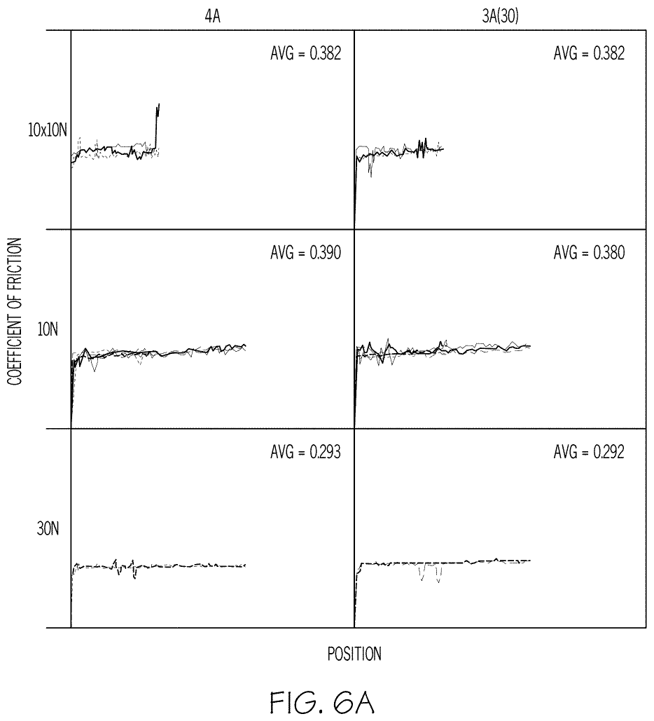

Referring now to FIGS. 6A-6C, the COF data for the modified coated glass vials of samples 3A, 3B, and 3C of Example 3 and the unmodified coated glass vials (no adhesion promoting region) of samples 4A, 4B, and 4C of Comparative Example 4 are graphically depicted. In FIGS. 6B and 6C, the 30 in parenthesis indicates the vials that were contacted with the aqueous treatment medium for 30 minutes, and the 45 in parenthesis indicates the vials that were contacted with the aqueous treatment medium for 45 minutes. In each of FIGS. 6A, 6B, and 6C, the average COF for each sample is also provided. Referring again to FIGS. 6A and 6B, for the 30 N and 10N single pass test conditions, the modified coated glass vials of Example 3 (3A, 3B(30), and 3B(45)) all outperformed the unmodified counterparts of Comparative Example 4 (4A and 4B) for all CP1 and r-Kaptan-CP1 coatings, as noted by the relatively smooth COF trace in FIGS. 6A and 6B for the modified coated glass vials of Example 3. This is also shown in the average COF for the modified coated glass vials of samples 3A and 3B of Example 3 being less than the average COF for the unmodified and coated vials of samples 4A and 4B of Comparative Example 4. For the modified coated glass vials of Sample 3B, increasing the contact time of the vials with the aqueous treatment medium from 30 minutes to 45 minutes further improved the average COF of the modified coated glass vials compared to the unmodified coated vials of Example 4B.

Referring now to FIG. 6C, the vials of Sample 3C(45), which were prepared by contacting the glass vials with the aqueous treating medium for 45 minutes prior to coating with the Coating C (PAA+SiO₂ nanoparticles) (Samples 3C(45) in FIG. 6C), outperformed the unmodified coated glass vials of Sample 4C of Example 4 in all three COF tests (30N, 10N, 10×10N).

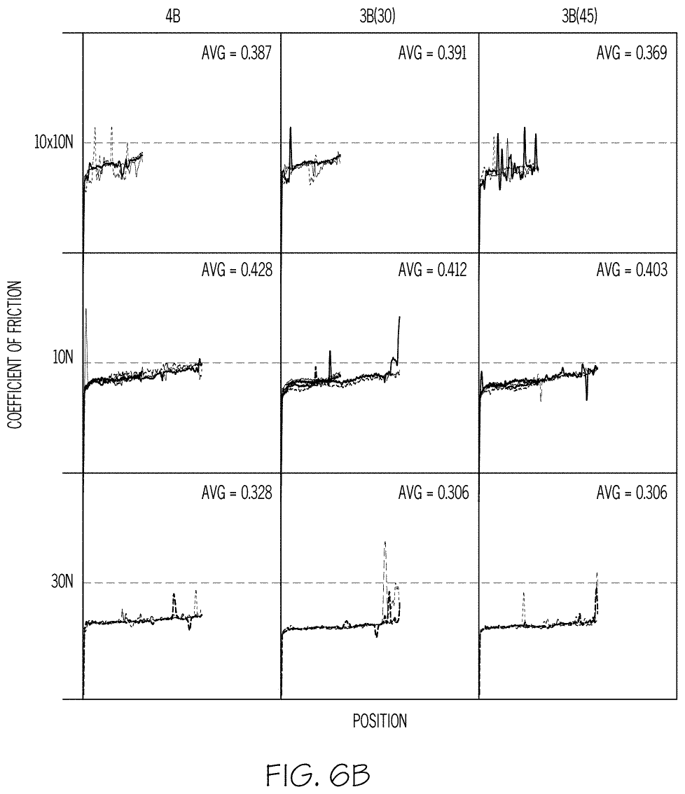

A complete evaluation of a coating's performance requires analysis of both the COF trace and the resulting scratch image. Referring now to FIG. 7, the scratch images of the uncoated glass vials of Sample 4D for Comparative Example 4 tested at a 10×10 N condition are shown. As shown in the scratch images of FIG. 7, the uncoated glass vial exhibited substantial scratches along the entire testing length.

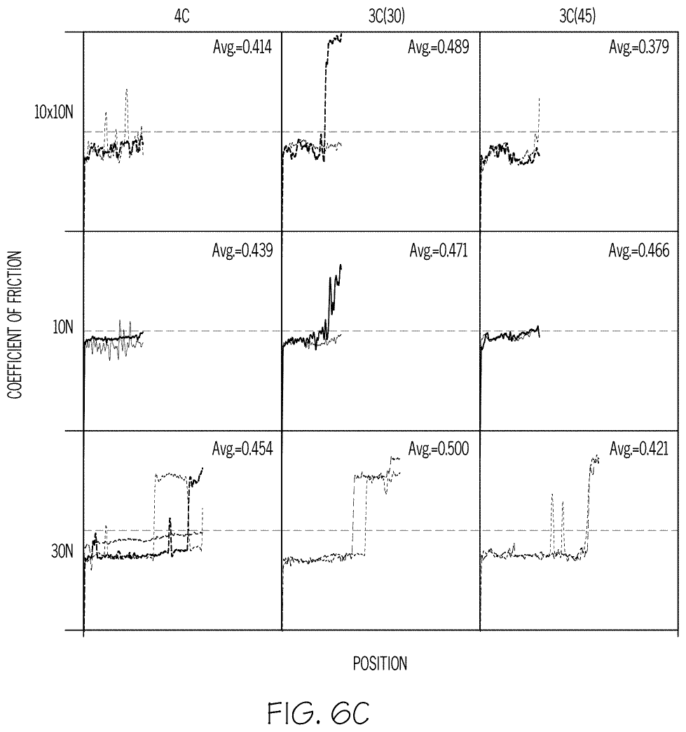

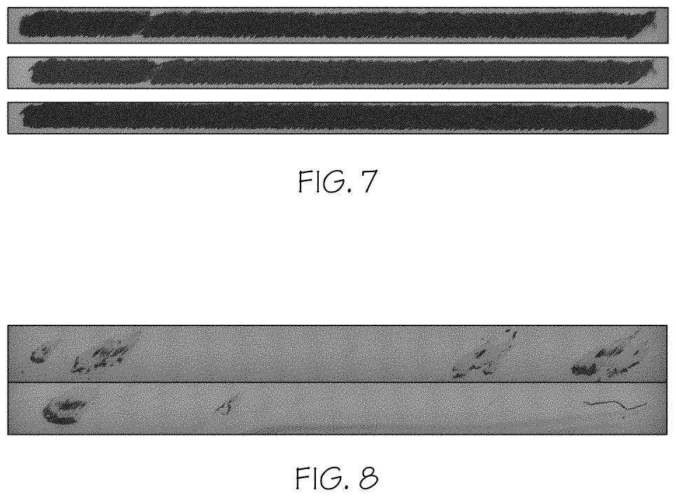

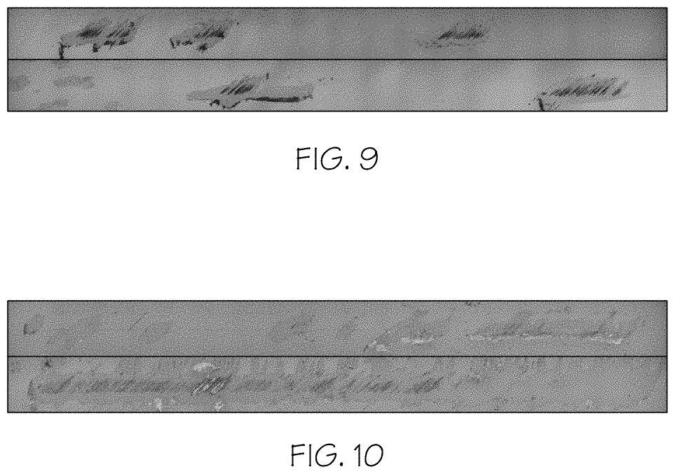

Referring now to FIGS. 8, 9, AND 10, scratch images of the treated coated glass vials of Sample 3A, 3B, and 3C of Example 3, respectively tested at a 10×10N condition are depicted. In each of FIGS. 8, 9, and 10, two scratch images are provided, one for each of the glass vials that are contacted together during the COF trace using the vial-to-vial testing jig of FIG. 4. Two features of coating failure—coating displacement or glass damage—are identified from the scratch images.

As shown in FIGS. 8, 9, and 10, respectively, the glass vials treated with the aqueous treating medium to produce the adhesion promoting layer and then coated with the coatings in Example 3 showed reduced density of glass damage sites on the treated and coated glass vials as compared to the bare untreated and uncoated glass vials of Sample 4D of Comparative Example 4 in FIG. 7. Coating displacement observed for the treated and coated glass vials of Example 3 (FIGS. 8-10) were also reduced relative to the untreated and uncoated glass vials of Sample 4D of Comparative Example 4.

### Comparative Example 6—Titania Coating

In Comparative Example 6, glass vials were coated with a titania coating (TiO₂) without being treated with the aqueous treating medium to produce the adhesion promoting region. The glass vials were the same as those described in Example 3. No adhesion promoting region was formed at the surface of the glass vials of Comparative Example 6. The coating was formed by applying a coating solution comprising a titania precursor and a diluent. The titania precursor was n-butyl polytitanate (TYZOR® BTP n-butyl polytitanate available from Dorf Ketal™). Following dip coating of the glass vials in the coating solution, the glass vials were cured to produce the coated glass vials having the titania coating of Comparative Example 6.

### Example 7—Refractive Index

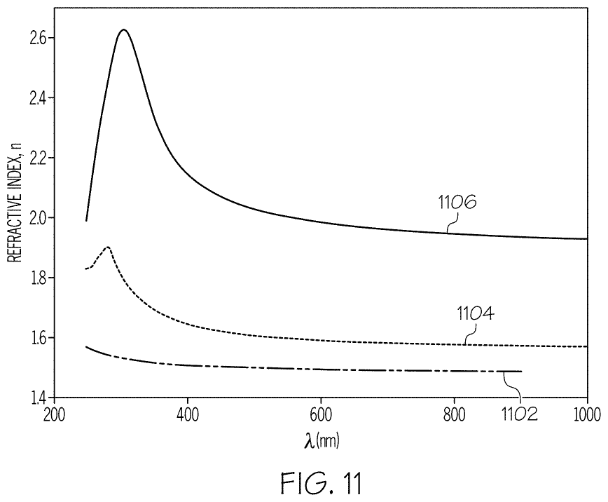

In Example 7, the uncoated glass vial of Comparative Sample 4D, the coated glass vials of Sample 3A of Example 3, and the coated glass vials of Comparative Example 6 were evaluated for refractive index according to the methods disclosed herein. Referring now to FIG. 11, the refractive index profile for each of the coated and uncoated glass vials is graphically depicted. Reference number 1102 refers to the uncoated glass vial, reference number 1104 refers to the coated glass vial of Sample 3A of Example 3, and reference number 1106 refers to the coated glass vials of Comparative Example 6. As shown in FIG. 11, the refractive index for the coated glass vials of Sample 3A of Example 3, which included the adhesion promoting region, had a refractive index profile across the wavelength range of 250 to 900 nm that was comparable to the refractive index profile of the uncoated glass vials of Sample 4D.

The following Table 3 provides the refractive index for each of the glass vials for a wavelength of 600 nm as well as the change in the refractive index compared to the uncoated glass vial of Comparative Sample 4D.

TABLE 3

| | | | Refractive | |
|---|---|---|---|---|
| | | | Index | |
| | | Ref. No. | (n) at | Δ |
| Sample | Coating | FIG. 11 | λ = 600 nm | (%) |
| Sample 4D | uncoated | 1102 | 1.49 | — |
| Sample 3A | adhesion | 1104 | 1.59 | 6.71% |
| | promoting | | | |
| | region and | | | |
| | CP1 coating | | | |
| Comp. Ex. 6 | titania coating | 1106 | 1.98 | 32.89 |

It should now be understood that the glass containers with low-frictive coatings described herein exhibit improved resistance to mechanical damage as a result of the application of the low frictive coating and, as such, the glass containers have enhanced mechanical durability. This property makes the glass containers well suited for use in various applications including, without limitation, pharmaceutical packaging materials.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A coated glass article comprising:
a glass article comprising a glass having a surface, wherein the surface comprises an adhesion promoting region comprising a nanostructure formed at the surface of the glass, wherein the adhesion promoting region comprises materials that are the same as one or more constituents of a glass composition of the glass; and
a coating disposed on the adhesion promoting region formed into the surface of the glass, the coating comprising one or more polymer coating materials.

2. The glass article of claim 1, wherein the glass article is a glass container comprising an exterior surface and an interior surface, wherein the exterior surface is the surface comprising the adhesion promoting region and the coating.

3. The glass article of claim 1, wherein the adhesion promoting region comprises one or more constituents of the glass that are present in amounts greater than or equal to 5 mol. % in the glass composition of the glass prior to formation of the adhesion promoting region.

4. The article of claim 1, wherein the adhesion promoting region comprises one or more of silica, alumina, alkali metal oxides, boron compounds, or combinations of these.

5. The glass article of claim 1, wherein the adhesion promoting region comprises a surface area of at least 1.05 times a surface area of the glass without the adhesion promoting region.

6. The glass article of claim 1, wherein the adhesion promoting region has a surface roughness Ra of greater than or equal to 0.3 nm.

7. The glass article of claim 1, wherein the adhesion promoting region and the coating are optically inert.

8. The glass article of claim 7, wherein the adhesion promoting region has a refractive index of within 10% of a refractive index of the glass without the adhesion promoting region, a Pegasus Number within 10% of a Pegasus Number of the glass without the adhesion promoting region, or both.

9. The glass article of claim 1, comprising a surface layer comprising the adhesion promoting region and a coating material of the coating disposed in valleys of the adhesion promoting region.

10. The glass article of claim 1, wherein the polymer coating material is a single component coating.

11. The glass article of claim 1, wherein the coating further comprises silica.

12. The glass article of claim 1, wherein the polymer coating material comprises a polyimide coating.

13. The glass article of claim 1, wherein the coating has a coefficient of friction of less than or equal to 0.7.

14. The glass article of claim 1, wherein the adhesion promoting region and the coating provide no impedance to optical inspection of the glass article, contents contained within the glass article, or both.

15. The glass article of claim 1, wherein the coated glass article comprises at least one of:
a light scattering that is different from the light scattering of the glass article without the coating and the adhesion promoting region by less than 10%,
a refractive index that is different from a refractive index of the glass article without the coating and the adhesion promoting region by less than 10%, and
a Pegasus Number that is different from a Pegasus Number of the glass article without the coating and the adhesion promoting region by less than 10%.

16. A method for producing a coated glass article, the method comprising:
providing a glass article comprising a glass having a surface;
forming an adhesion promoting region at the surface, wherein the adhesion promoting region comprises a nanostructure comprising materials that are the same as constituents of the glass; and
after forming the adhesion promotion region at the surface, applying a coating to the adhesion promoting region to produce the coated glass article, wherein the coating comprises at least one polymer coating material.

17. The method of claim 16, wherein the forming the adhesion promoting region at the surface comprises contacting the surface of the glass article with an aqueous treating medium.

18. The method of claim 17, comprising the contacting the surface of the glass article with the aqueous treating medium comprising a low fluoride content aqueous solution comprising ammonium bifluoride and citric acid, where the contacting removes material from the surface of the glass article to form the nanoporous structure of the adhesion promoting region.

19. The method of claim 18, wherein the aqueous treating medium comprises from 0.026 molar (M) to 0.26 M ammonium bifluoride and from 0.5 M to 2 M citric acid.

20. The method of claim 17, comprising contacting the surface of the glass article with the aqueous treating medium at a temperature of from 0° C. to 105° C. and a time of from 5 minutes to 48 hours.

21. The method of claim 17, further comprising leaching low durability constituents from the glass at the surface of the glass before contacting with the aqueous treating medium.

22. The method of claim 16, wherein the adhesion promoting region comprises a surface area of at least 1.05 times a surface area of the glass without the adhesion promoting region.

23. The method of claim 16, wherein the adhesion promoting region has a surface roughness Ra of greater than or equal to 0.3 nm.

24. The method of claim 16, wherein the adhesion promoting region is optically inert.

25. The method of claim 16, further comprising curing the coated glass article at a curing temperature for a cure time, wherein the curing temperature and cure time are sufficient to remove diluent and cure the polymer coating material to produce the coating on the surface of the glass article.
